(19) United States
(12) Patent Application Publication
(10) Pub. No.: US 2026/0291898 A1
(43) Pub. Date: Sep. 24, 2026

(54) METHOD AND DEVICE FOR PROVIDING PRIVATE CHAT SERVICE

(71) Applicant: WEVERSE COMPANY INC., Seongnam-si, Gyeonggi-do (KR)

(72) Inventors: Yoon Jung JEONG, Seongnam-si, Gyeonggi-do (KR); Eun Soo SOHN, Seongnam-si, Gyeonggi-do (KR); Ji Eun LEE, Seongnam-si, Gyeonggi-do (KR)

(73) Assignee: WEVERSE COMPANY INC., Seongnam-si, Gyeonggi-do (KR)

(21) Appl. No.: 19/476,653

(22) PCT Filed: Apr. 17, 2024
(86) PCT No.: PCT/KR2024/005186

§ 371 Date: Oct. 17, 2025

(30) Foreign Application Priority Data
Apr. 19, 2023 (KR) 10-2023-0051349
Jul. 28, 2023 (KR) 10-2023-0098809

(51) Int. Cl. H04L 51/04; H04L 51/18; H04L 51/216

(52) U.S. Cl. CPC H04L 51/04; H04L 51/18; H04L 51/216

(57) ABSTRACT

A method for providing a private chat service by relaying messages between an artist terminal and a plurality of fan terminals via a private chat service relay server includes: receiving an artist message for transmission from the artist terminal to a fan terminal among the fan terminals; transferring the artist message to a determined reviewer terminal; waiting to send the artist message to the fan terminal until the reviewer terminal approves the sending of the artist message; storing the artist message in the private chat service relay server in response to the reviewer terminal approving the sending of the artist message; converting the artist message stored in the private chat service relay server into a private message; and transferring the private message to the fan terminal. The private message is a message in which a word or keyword of the artist messages is converted according to a reception entity.

### CROSS-REFERENCE TO RELATED APPLICATION(S)

This application is a national stage entry of International Application No. PCT/KR2024/005186, filed Apr. 17, 2024, which claims priority to and the benefits of Korean Patent Application No. 10-2023-0098809, filed Jul. 28, 2023, and Korean Patent Application No. 10-2023-0051349, filed Apr. 19, 2023, in the Korean Intellectual Property Office under 35 U.S.C. §§ 119 (a), 365(b), the entire contents of which are incorporated herein by reference.

### BACKGROUND

### 1. Technical Field

The disclosure generally relates to a method and device for providing a private chat service capable of increasing message transmission and reception processing speeds between an artist and a plurality of fans following the artist, and performing a review of artist messages.

### 2. Description of Related Art

With the recent growth of the entertainment industry and the advancement of IT technology, social networking services and fan platforms for communication between celebrities, artists, and fans are increasing. These social networking services may serve as a platform for fan communities. For example, the social networking services may provide (e.g., comprehensively provide) communication with celebrities and artists, live broadcasts, and fan community functions.

In addition, these fan platforms are expanding functions beyond functions of traditional communities to a wide range, including selling and purchasing goods, ticketing concerts and events, providing original content, and applying non-fungible tokens (NFTs).

As the functions of fan platforms expand, the notifications and notifying messages provided to users may also be diverse. For example, in a case that a function is provided that allows an artist to directly create posts, postings, messages, or videos, and post the same to the community, users may receive push notifications after, e.g., immediately after, the artist creates posts, or comments, or receive notifications of various benefits for membership subscribers. In addition, notifications and messages with different content may be provided depending on various functions.

As such, not only are the functions of fan platforms expanding, but as the entertainment market globalizes, the number of artists, communities, and users of fan platforms is also rapidly increasing. In addition, as the influence of the “Korean Wave” expands over users from all over the world, there are difficulties in processing (e.g., immediately processing) messages between artists and a plurality of fans and reviewing reply messages of the artists to a plurality of fan messages in real time.

The background provided herein is for the purpose of generally presenting the context of the disclosure. Work of the presently named inventors, to the extent that it is described in this background section, as well as aspects of the description that may not otherwise qualify as prior art at the time of filing, are neither expressly nor impliedly admitted as prior art against the disclosure.

### SUMMARY

One or more embodiments provide a method and device capable of providing a private chat service that performs a review of artist messages in a chat between an artist and a plurality of fans.

One or more embodiments provide a method and device capable of providing a private chat service that increase message transmission and reception speeds between an artist and a plurality of fans.

One or more embodiments provide a method and device capable of providing a private chat service enabling private messages for each user.

Additional aspects will be set forth in the detailed description, which follows, and in part, will be apparent from the disclosure, or may be learned by practice of the disclosed embodiments and/or the claimed subject matter.

According to an embodiment, a method for providing a private chat service by relaying messages between an artist terminal and a plurality of fan terminals via a private chat service relay server includes: receiving an artist message for transmission from the artist terminal to a fan terminal among the plurality of fan terminals; transferring the artist message to a determined reviewer terminal; waiting to send the artist message to the fan terminal until the reviewer terminal approves the sending of the artist message; storing the artist message in a private chat service relay server in response to the reviewer terminal approving the sending of the artist message; converting the artist message stored in the private chat service relay server into a private message; and transferring the private message to the fan terminal. The private message is a message in which a word or keyword of messages is converted according to a reception entity.

In some embodiments, transferring the artist message to the determined reviewer terminal may include: storing the artist message and artist information in an artist sending database; generating and providing a message feed to the reviewer terminal; and receiving the artist message and the artist information from the artist sending database, generating a review message, and transferring the review message to the reviewer terminal in response to a message view being requested from the reviewer terminal. The message feed may include a notification and a post indicating receipt of a message on the reviewer terminal.

In some embodiments, generation of the review message and transfer of the review message to the reviewer terminal may include: generating a text message containing content of the artist message and a link for selecting whether to approve the sending of the artist message; and transferring the text message and the link to the reviewer terminal.

In some embodiments, generation of the review message and transfer of the review message to the reviewer terminal may include: generating a message containing content of the artist message and a link for selecting whether to approve the sending of the artist message; and transferring the message to the reviewer terminal. The message may be a message of an application enabling transmission and reception of messages.

In some embodiments, waiting to send the artist message may include: deleting the artist message stored in the artist sending database in response to the reviewer terminal rejecting the sending of the artist message; and transferring a message rejecting the sending of the artist message to the artist terminal.

In some embodiments, storage of the artist message in the private chat service relay server may include: receiving an amended message for the artist message from the reviewer terminal; storing the amended message in the private chat service relay server; converting the amended message into the private message; and transferring the private message to the fan terminal.

In some embodiments, conversion of the artist message into the private message and transfer of the private message to the fan terminal may include: storing the artist message and artist information or the amended message and artist information in a direct message (DM)-specific database; generating and providing the message feed to the artist terminal or the plurality of fan terminals; receiving a request for a message update of a private chat from a first fan terminal requesting a view of the artist message among the plurality of fan terminals; generating the private message corresponding to the first fan terminal based on the amended message or artist message and fan account information corresponding to the first fan terminal; and transferring the private message to the first fan terminal. The DM-specific database may be configured to store artist messages on an artist-by-artist basis.

In some embodiments, storage of the artist message and the artist information or the amended message and the artist information in the DM-specific database may include: matching a plurality of individual databases respectively corresponding to the plurality of fan terminals; generating a plurality of private messages respectively corresponding to the plurality of fan terminals based on the amended message or artist message and fan account information respectively corresponding to the plurality of fan terminals; and storing the plurality of private messages respectively in the plurality of individual databases corresponding to the plurality of fan terminals based on the fan account information.

In some embodiments, transferring the private message to the first fan terminal may include: deleting the artist message stored in the DM-specific database in response to completion of storage of the plurality of private messages in the plurality of individual databases; receiving the private message from a first individual database corresponding to the first fan terminal; and transferring the private message to the first fan terminal.

In some embodiments, transferring the private message to the first fan terminal may include: deleting the artist message stored in the DM-specific database in response to expiration of a determined reference time since the artist message and artist information were stored in the DM-specific database; receiving the private message from the first individual database; and transferring the private message to the first fan terminal.

According to an embodiment, a method for providing a private chat service by relaying messages between an artist terminal and a plurality of fan terminals via a private chat service relay server includes: displaying, on the artist terminal, a message input area and a message display area in association with the private chat service; generating a review request message display area; displaying an artist message in the review request message display area in response to the artist message being input using the message input area; transferring the artist message to a determined reviewer terminal; converting the artist message into a private message; transferring the private message to a fan terminal among the plurality of fan terminals in response to the reviewer terminal approving sending of the artist message; and moving the artist message displayed in the review request message display area to being displayed in the message display area in response to the artist message being transferred to the fan terminal. The private message is a message in which a word or keyword of the artist message is converted according to a reception entity.

In some embodiments, transferring the artist message to the determined reviewer terminal may include: storing the artist message and artist information in an artist sending database; displaying a message feed provided to the reviewer terminal; and displaying the artist message and artist information in response to a message view being requested from the reviewer terminal. The message feed nay include a notification and a post indicating receipt of a message on the reviewer terminal.

In some embodiments, displaying the artist message and the artist information may include displaying, on the reviewer terminal, a review message display area in which content of the artist message is displayed and a message review approval selection area for selecting whether to approve the sending of the artist message.

In some embodiments, movement and display of the artist message to the message display area may include: deleting the artist message stored in the artist sending database in response to the reviewer terminal rejecting the sending of the artist message; and displaying a sending rejection message of the artist message on the artist terminal.

In some embodiments, displaying the artist message and the artist information may include: displaying an amended message input area describing amended details of the artist message on the reviewer terminal; storing the amended message input using the amended message input area in the private chat service relay server; converting the amended message into the private message; and transferring the private message to the fan terminal.

In some embodiments, conversion of the amended message into the private message and transferring the private message to the fan terminal may include: storing the artist message and the artist information or the amended message and the artist information in a direct message (DM)-specific database; generating and providing the message feed to the artist terminal or the plurality of fan terminals; receiving a request for a message update in the private chat from a first fan terminal requesting a view of the artist message among the plurality of fan terminals; generating the private message corresponding to the first fan terminal based on the amended message or the artist message and fan account information corresponding to the first fan terminal; and transferring the private message to the first fan terminal. The DM-specific database may be configured to store artist messages on an artist-by-artist basis.

In some embodiments, storage of the artist message and the artist information or the amended message and the artist information in the DM-specific database may include: matching a plurality of individual databases respectively corresponding to the plurality of fan terminals; generating a plurality of private messages respectively corresponding to the plurality of fan terminals based on the amended message or the artist message and fan account information respectively corresponding to the plurality of fan terminals; and storing the plurality of private messages respectively in the plurality of individual databases corresponding to the plurality of fan terminals based on the fan account information.

In some embodiments, transferring the private message to the first fan terminal may include: deleting the artist message stored in the DM-specific database in response to completion of storage of the plurality of private messages in the plurality of individual databases; receiving the private message from a first individual database corresponding to the first fan terminal; and transferring the private message to the first fan terminal.

According to an embodiment, a device for providing a private chat service by relaying messages between an artist terminal and a plurality of fan terminals via a private chat service relay server includes: a communication module, a memory, a direct message (DM)-specific database, a plurality of individual databases, and a processor. The communication module transmits and receives information among the artist terminal, a reviewer terminal, a fan terminal, and the private chat service relay server. The memory stores a private chat service program. The DM-specific database stores the messages on an artist-by-artist basis. The plurality of individual databases are respectively allocated to users of the private chat service and respectively stores the messages for the users. The processor executes the private chat service program stored in the memory. In response to execution of the private chat service program, the processor is configured to: receive an artist message for transmission from the artist terminal to a fan terminal among the plurality of fan terminals; transfer the artist message to a determined reviewer terminal; wait to send the artist message to the fan terminal until the reviewer terminal approves the sending of the artist message; store the artist message in the private chat service relay server in response to the reviewer terminal approving the sending of the artist message; convert the artist message stored in the private chat service relay server into a private message; and transfer the private message to the fan terminal. The private message is a message in which a word or keyword of the artist message is converted according to a reception entity.

According to various embodiments, methods and devices for providing a private chat service may be capable of providing a review function of artist messages in a chat between an artist and a plurality of fans.

According to some embodiments, methods and devices for providing the private chat service may be capable of increasing message transmission and reception speeds between an artist and a plurality of fans.

According to some embodiments, methods and devices for providing the private chat service may provide private messages for each user of the private chat service.

The foregoing general description and the following detailed description are illustrative and explanatory and are intended to provide further explanation of the claimed subject matter.

### BRIEF DESCRIPTION OF THE DRAWINGS

Various embodiments disclosed herein are illustrated by way of example, and not by way of limitation, in the figures of the accompanying drawings, in which like reference numerals and/or characters refer to similar elements.

FIG. 1 is a schematic diagram illustrating a communication connection of a device for providing a private chat service according to an embodiment.

FIG. 2 is a schematic block diagram illustrating a structure of a private chat service relay server according to an embodiment.

FIG. 3 is a schematic block diagram illustrating a terminal according to an embodiment.

FIG. 4 is a schematic diagram illustrating some functions of the private chat service relay server according to an embodiment.

FIG. 5 is a schematic data flow diagram illustrating data processing for fan message storage according to an embodiment.

FIG. 6 is a schematic data flow diagram illustrating artist message storage according to an embodiment.

FIG. 7 is a schematic data flow diagram illustrating private chat message viewing of a fan terminal according to an embodiment.

FIG. 8 is a schematic data flow diagram illustrating private chat message viewing of a fan terminal according to an embodiment.

FIG. 9 is a schematic data flow diagram illustrating private chat message viewing of an artist terminal according to an embodiment.

FIG. 10 is a schematic flowchart of a method for storing a fan message according to an embodiment.

FIG. 11 is a schematic flowchart of a method for storing an artist message according to an embodiment.

FIG. 12 is a schematic flowchart of a private chat update method of a fan terminal according to an embodiment.

FIG. 13 is a schematic flowchart of a private chat update method according to an embodiment.

FIG. 14 is a schematic flowchart of a private chat update method of an artist terminal according to an embodiment.

FIG. 15 is a schematic diagram illustrating a communication connection of a device for providing a private chat service according to an embodiment.

FIG. 16 is a schematic diagram illustrating an interface provided to an artist terminal according to an embodiment.

FIG. 17 is a schematic diagram illustrating an interface provided to a reviewer terminal according to an embodiment.

FIG. 18 is a schematic data flow diagram illustrating an artist message review according to an embodiment.

FIG. 19 is a schematic flowchart of an artist message review method according to an embodiment.

FIG. 20 is a schematic flowchart of an artist message review method according to an embodiment.

FIG. 21 is a schematic block diagram illustrating functions of a processor according to an embodiment.

FIG. 22 is a schematic data flow diagram illustrating fan message filtering according to an embodiment.

FIG. 23 is a schematic data flow diagram illustrating artist message filtering according to an embodiment.

FIG. 24 is a schematic flowchart of a fan message filtering method according to an embodiment.

FIG. 25 is a schematic flowchart of an artist message filtering method according to an embodiment.

### DETAILED DESCRIPTION OF THE EMBODIMENTS

In the following description, for the purposes of explanation, numerous specific details are set forth to provide a thorough understanding of various embodiments or implementations. The terms “embodiments” and “implementations” may be used interchangeably to describe one or more non-limiting examples of systems, apparatuses, methods, etc., described herein. It is apparent, however, that various embodiments may be practiced without these specific details or with one or more equivalent arrangements. In other instances, known structures and devices are shown in block diagram form to avoid unnecessarily obscuring various embodiments. Further, various embodiments may be different, but do not have to be exclusive. For example, specific shapes, configurations, and characteristics of an embodiment may be used or implemented in another embodiment without departing from the teachings of the disclosure.

Unless otherwise specified, the illustrated embodiments are to be understood as providing example features of varying detail of some embodiments. Thus, unless otherwise specified, the aspects, components, features, modules, regions, structures, units, etc. (hereinafter individually or collectively referred to as an “element” or “elements”), of the various illustrations may be otherwise combined, separated, interchanged, and/or rearranged without departing from the teachings of the disclosure.

In the accompanying drawings, the size and relative sizes of elements may be exaggerated for clarity and/or descriptive purposes. As such, the sizes and relative sizes of the respective elements are not necessarily limited to the sizes and relative sizes shown in the drawings. In a case that an embodiment may be implemented differently, a specific process order may be performed differently from the described order. For example, two consecutively described processes may be performed substantially at the same time or performed in an order opposite the described order. Also, like reference numerals and/or reference characters denote like elements.

In a case that an element, such as a structure, is referred to as being “on,” “over,” “connected to (or with),” or “coupled to (or with)” another element, it may be directly on, directly over, directly connected to (or with), or directly coupled to (or with) the other element or at least one intervening element may be present. However, in a case that an element is referred to as being “directly on,” “directly over,” “directly connected to (or with),” or “directly coupled to (or with)” another element, there are no intervening elements present. Other terms and/or phrases, if used herein, to describe a relationship between elements should be interpreted in a like fashion, such as “between” versus “directly between,” “adjacent” versus “directly adjacent,” “on” versus “directly on,” “contacting” versus “directly contacting,” “touching” versus “directly touching,” etc. Further, the term “connected” may refer to physical, electrical, and/or fluid connection.

For the purposes of this disclosure, a first axis extending along a first direction DR1, a second axis extending along a second direction DR2, and a third axis extending along a third direction DR3 are not limited to three axes of a rectangular coordinate system, such as x, y, and z axes of a Cartesian coordinate system, and may be interpreted in a broader sense. For example, the first axis, the second axis, and the third axis may be perpendicular to one another, or may represent different directions that are not perpendicular to one another. Further, if used herein, the phrases “at least one of X, Y, . . . , and Z” and “at least one selected from the group consisting of X, Y, . . . , and Z” may be construed as X only, Y only, . . . , Z only, or any combination of two or more of X, Y, . . . , and Z, such as, for instance, XYZ, XYY, YZ, and ZZ. Also, if used herein, the term “and/or” includes any and all combinations of one or more of the associated listed items.

Although the terms “first,” “second,” “third,” etc., may be used herein to describe various elements, these elements should not be limited by these terms. These terms are used to distinguish one element from another element. Thus, a first element discussed below could be termed a second element without departing from the teachings of the disclosure. To this end, use of such identifiers, e.g., “a first element,” should not be read as suggesting, implicitly or inherently, that there is necessarily another instance, e.g., “a second element.”

Spatially relative terms, such as “beneath,” “below,” “under,” “lower,” “above,” “upper,” “over,” “higher,” “side” (e.g., as in “sidewall”), and the like, may be used herein for descriptive purposes, and thereby, to describe one element's spatial relationship to at least one other element as illustrated in the drawings. Spatially relative terms are intended to encompass different orientations of, for instance, an apparatus in use, operation, and/or manufacture in addition to the orientation depicted in the drawings. For example, if the apparatus in the drawings is turned over, elements described as “below” or “beneath” other elements or features would then be oriented “above” or “over” the other elements or features. Thus, the term “below” can encompass both an orientation of above and below. Further, the apparatus may be otherwise oriented (e.g., rotated 90 degrees or at other orientations), and as such, the spatially relative descriptors used herein interpreted accordingly.

The terminology used herein is for the purpose of describing some embodiments and is not intended to be limiting. As used herein, the singular forms, “a,” “an,” and “the” are intended to include the plural forms as well, unless the context clearly indicates otherwise. It is to be understood that the phrases “for each <item> of the one or more <items>,” “each <item> of the one or more <items>,” and/or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite dictionary definitions of “each” frequently defining the term to refer to “every one of two or more things”) and would not imply that there must be at least two of those items. Similarly, the term “set” or “subset” should not be viewed, in and of itself, as necessarily encompassing a plurality of items—it is to be understood that a set or a subset can encompass only one member or multiple members (unless the context indicates otherwise).

The terms “comprises,” “comprising,” “includes,” “including,” “has,” “have,” and/or “having” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, if used herein, the terms “substantially,” “about,” “approximately,” and other similar terms, are used as terms of approximation and not as terms of degree, and as such, are utilized to account for inherent deviations in measured, calculated, and/or provided values that would be recognized by one of ordinary skill in the art. Accordingly, the terms “substantially,” if used herein, and unless otherwise specified, may mean within 5% of a referenced value. For example, substantially perpendicular may mean within ±5% of being parallel. The terms “about” and “approximately,” if used herein, and unless otherwise specified, may mean within one or more standard deviations, such as within ±30%, ±20%, ±10%, or ±5% of a stated value. Moreover, the term “between,” if used herein in association with a range of values, is to be understood, unless otherwise indicated, as being inclusive of the start and end values of the range. For example, between 1 and 5 is to be understood as being inclusive of the numbers 1, 2, 3, 4, and 5, not just the numbers 2, 3, and 4. Furthermore, the expression “being the same” may mean “being substantially the same.” For instance, the expression “being the same” may include a range that can be tolerated by those skilled in the art. Other expressions may also be expressions from which “substantially” has been omitted.

As customary in the field, some embodiments may be described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the disclosure. Further, the blocks, units, and/or modules of some embodiments may be physically combined into more complex blocks, units, and/or modules without departing from the scope of the disclosure.

Unless otherwise defined, all terms (including technical and scientific terms) used herein have the same meaning as commonly understood by one of ordinary skill in the art to which this disclosure pertains. Terms, such as those defined in commonly used dictionaries, should be interpreted as having a meaning that is consistent with their meaning in the context of the relevant art and are not to be interpreted in an idealized or overly formal sense, unless expressly so defined herein.

Hereinafter, various embodiments will be described with reference to the accompanying drawings.

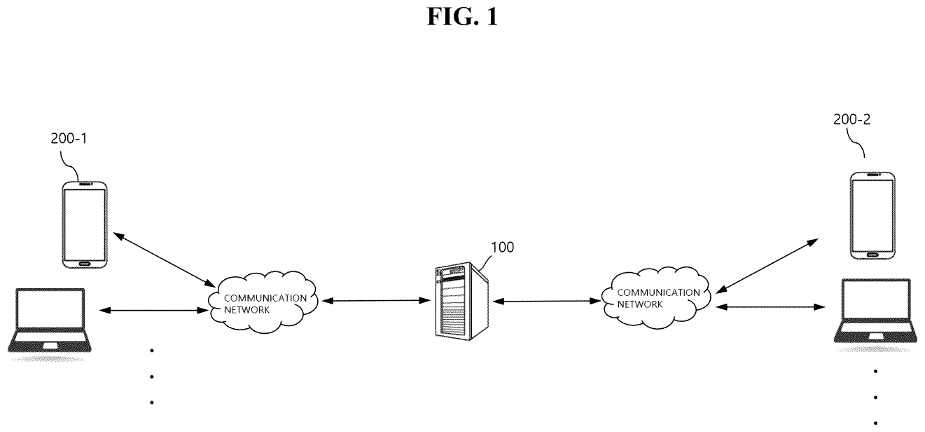

A device for providing a private chat service according to an embodiment will now be described with reference to FIG. 1.

FIG. 1 is a schematic diagram illustrating a communication connection between a private chat service relay server 100 and a terminal 200 according to an embodiment.

Referring to FIG. 1, the private chat service relay server 100 is communicatively connected to one or more terminals, e.g., artist terminal 200-1, fan terminal 200-2, and/or the like, using a communication network. Hereinafter, the one or more terminals may be collectively or individually referred to as terminal(s) 200. The private chat service relay server 100 refers to a device for providing message transmission and reception between users using a fan platform or a social network service, and may correspond to a fan platform server or social network service server. The terminal 200 includes an artist terminal 200-1 used by celebrities or artists, and a fan terminal 200-2 used by fans following the celebrities or artists. The terminal 200 may refer to a device that displays messages and notifications received from the private chat service relay server 100 to a user.

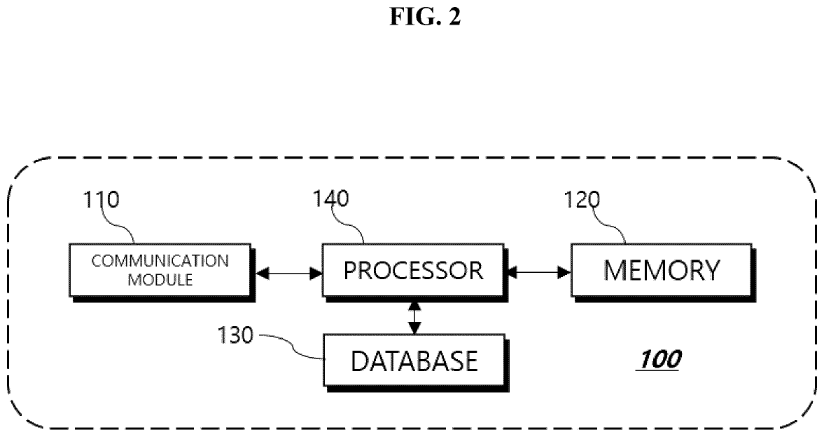

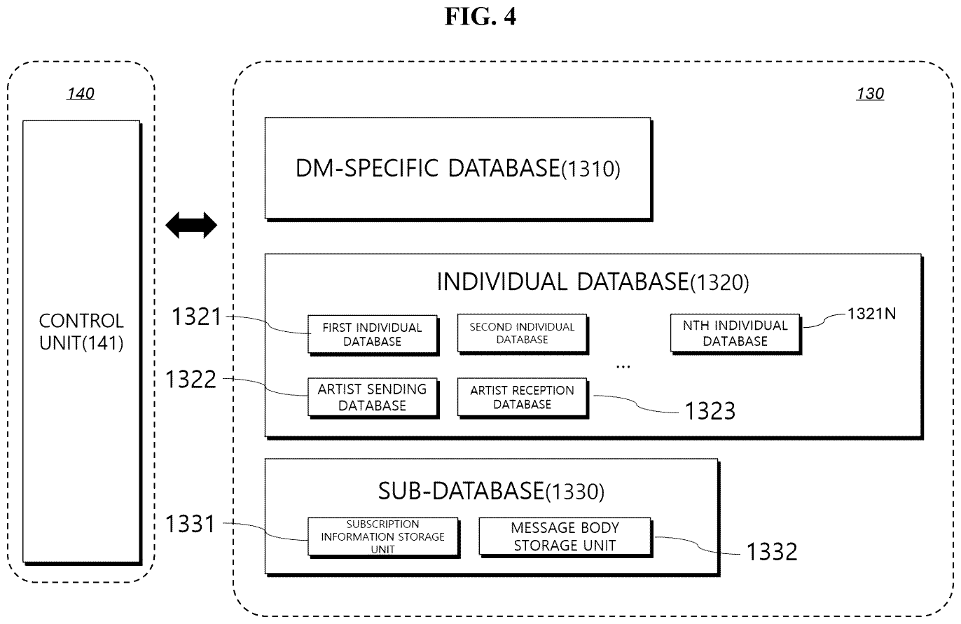

The private chat service relay server 100 may generate message and notification lists on the fan platform or the social network service and provide the message and notification lists to users. Rather than merely providing messages and notifications to the users, the users may be provided with notification messages and notification lists personalized based on user-specific filtering information. In some embodiments, the private chat service relay server 100 may build an individual (or profile) database for each user and store messages individually. An illustrative configuration of the private chat service relay server 100 is described in more detail with reference to FIGS. 2 and 4, which are described below.

The terminal 200 may refer to all types of handheld-based wireless communication devices, such as a notebook on which a web browser is mounted, a desktop, a laptop, a wireless communication device in which portability and mobility are guaranteed, a smart phone, and a tablet personal computer (PC). It is contemplated, however, that the terminal 200 may include any other suitable communication device, whether or not handheld-based or wireless.

In addition, the communication network illustrated in FIG. 1 may be implemented as a wired network, such as a local area network (LAN), a wide area network (WAN), or a value added network (VAN), or any suitable type of wireless network, such as a mobile radio communication network, a satellite communication network, etc. In some implementations, the communication network may be a combination of one or more wired networks and/or wireless networks.

An illustrative structure of the private chat service relay server 100 according to an embodiment will now be described in more detail with reference to FIG. 2.

FIG. 2 is a schematic block diagram illustrating a structure of the private chat service relay server 100 according to an embodiment.

Referring to FIG. 2, the private chat service relay server 100 may include a communication module 110, a memory 120, and a processor 140, and may further include a database 130. The communication module 110 performs information transmission and reception with, for instance, the terminal 200. The communication module 110 may include a device including hardware and software configured to transmit and receive signals, such as control signals, data signals, etc., using wired and/or wireless connections with other network devices.

The memory 120 may store a private chat program and data associated with the private chat program. The name of the private chat program is provided for convenience of explanation and does not limit the function of the program to the name itself. The memory 120 may store at least one of information and data input to the communication module 110, information and data for functions performed by the processor 140, data generated by the execution of the processor 140, and/or any other suitable information or data.

The memory 120 is used as a common term for a non-volatile storage device that continuously maintains stored information even when power is not supplied and a volatile storage device that uses power to maintain stored information. The memory 120 may perform a function of temporarily and/or permanently storing data processed by the processor 140. The memory 120 may include magnetic storage media or flash storage media in addition to volatile storage devices that use power to maintain stored information, but embodiments are not limited to these types of memories and any suitable non-transitory storage medium may be utilized.

The database 130 may store data related to artist information, user information, subscription information, artist messages, fan messages, and/or private messages that are converted and provided for one or more (e.g., each) fan user. The database 130 may configure a portion of the memory 120, but may not be located inside the private chat service relay server 100, and may be physically and/or communicatively connected to the outside of the private chat service relay server 100 to perform data transmission and reception using a communication connection.

In some embodiments, the database 130 may be formed to store message data on an artist basis (e.g., an artist-by-artist basis) or a user basis (e.g., a user-by-user basis). It is also contemplated that groups may be established and the message data may be stored on a group-by-group basis. In some embodiments, a group my include one or more artists, one or more fans, or any combination of at least one artist and at least one fan. Any other suitable storage methodology may be utilized in association with embodiments described herein. An example detailed configuration of the database 130 is described in more detail with reference to FIG. 4 described later.

The processor 140 may configured to execute the private chat program, which may be stored in the memory 120. The processor 140 may include various types of devices that control and process data. The processor 140 may be a data processing device built into hardware that has a physically structured circuit to perform a function expressed by a code or command included in a program. In an example, the processor 140 may be implemented in the form of a microprocessor, a central processing unit (CPU), a processor core, a multiprocessor, an application-specific integrated circuit (ASIC), or a field programmable gate array (FPGA), but embodiments are not limited to these example types of devices.

The processor 140 may be configured to execute the private chat program and perform the functions and procedures described herein.

Referring to FIGS. 1 and 2 together, the processor 140 may receive an artist message generated from the artist terminal 200-1 and transmit the artist message to the fan terminal 200-2 following the artist associated with the artist message. In some implementations, the processor 140 may receive a fan message generated from the fan terminal 200-2 and provide the fan message to the artist terminal 200-1.

According to some embodiments, the processor 140 may generate a private message in which the content of the artist message is converted for one or more (e.g., each) fan user and provide the same to the fan terminal 200-2. To increase the message conversion speed for a number of fan users, the processor 140 may generate the private message for each fan user and store the private message in a database for each user. Accordingly, even in cases in which a plurality of users use the private chat service, the private message may be provided immediately or at least relatively quickly. For instance, the private message may be provided using “push” methodology, e.g., a delivery method in which information (e.g., a private message) is actively sent from the private chat service to one or more recipients (e.g., fans) regardless of whether the recipients are actively seeking or requesting the information. It is also possible to provide the private chat service at an increased speed compared to generating and providing the private message based on a message viewing request of a user, such as in response to an interactive informational exchange or pull request.

In some implementations, the processor 140 may store the artist message in the database 130, and while or as part of the private message being generated and stored in a user-specific database, the processor 140 may read the artist message from the database 130 to generate and provide the private message. After the private message is stored in the user-specific database, the processor 140 may delete duplicate artist messages and receive message information stored in the user-specific database to provide the private chat service to a user. It is contemplated, however, that other temporal processing schemes for private message generation, storage, and dissemination may be utilized in association with embodiments described herein.

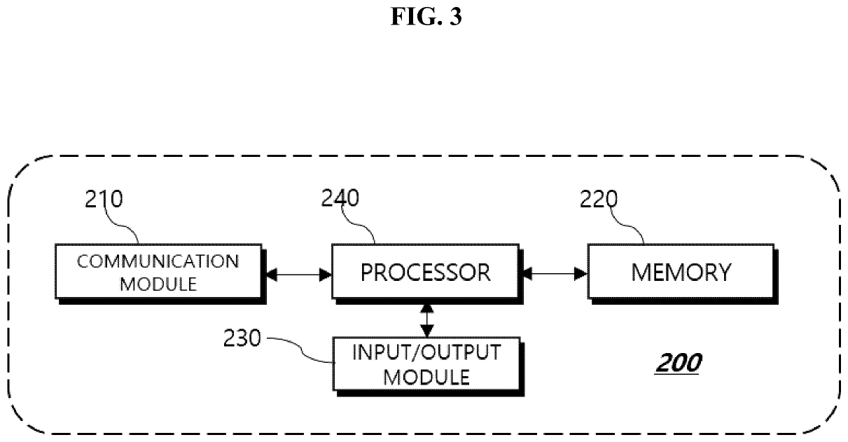

FIG. 3 is a schematic block diagram illustrating a configuration of the terminal 200 according to an embodiment.

Referring to FIG. 3, the terminal 200 may include a memory 220, an input/output module 230, and a processor 240, and may further include a communication module 210.

The communication module 210 may transmit and receive information with an external database or external device. The external device may be the private chat service relay server 100 in FIG. 1 described above. The memory 220 may store the private chat program and data associated with the private chat program. The name of the private chat program is provided for convenience of explanation and does not limit the function of the program to the name itself. The input/output module 230 may receive information or data transmitted from the outside to the terminal 200, or output the information or data held by the terminal 200 to the outside. For example, the input/output module 230 may include a display, a touchscreen, a touchpad, a mouse, a keyboard, and/or the like. The processor 240 executes the private chat program stored in, for example, the memory 220. Additional descriptions of the communication module 210, the memory 220, and the processor 240 correspond with the descriptions of the communication module 110, the memory 120, and the processor 140 previously described with reference to FIG. 2.

The processor 240 may be configured to execute the private chat program to perform the functions and procedures described herein.

The processor 240 may transfer an artist message or fan message generated in the terminal 200 to the private chat service relay server 100. In some implementations, the processor 240 may receive artist messages, fan messages, private messages, feeds, and/or alarms stored and generated in the private chat service relay server 100.

Some example operations of the processor 140 and the database 130 according to an embodiment will now be described in more detail with reference to FIG. 4.

FIG. 4 is a schematic diagram illustrating some functions of the private chat service relay server according to an embodiment.

Referring to FIG. 4, the processor 140 may perform the functions of a control unit (or controller) 141 and a message queue unit (or message queue) (not shown) described below. The database 130 may include a direct message (DM)-specific database 1310, an individual database 1320, and a sub-database 1330.

The control unit 141 may perform the function of a controller for storing artist messages and fan messages generated from the artist terminal 200-1 and the fan terminal 200-2 in the database 130 or reading messages from the database 130 for private chat updates. The message queue unit (not shown) performs a message issuing function to issue artist messages or fan messages stored in the database 130 to a reception entity, such as the artist terminal 200-1 of FIG. 1, a fan terminal 200-2 of FIG. 1, etc.

The DM-specific database 1310 may store messages on a private chat basis (e.g., a private chat-by-private chat basis) or an artist basis (e.g., an artist-by-artist basis). The private chat basis may refer to a basis of a chat room where messages are transmitted and received between fan users and artists. The individual database 1320 may be built (or otherwise configured) to correspond to each user so that messages may be stored on a user basis. For instance, a first individual database 1321 to an Nth individual database 1321N may be formed to correspond to the number of users.

In some implementations, the individual database 1320 may include an artist sending database 1322 for storing messages sent by an artist and an artist reception database 1323 for storing messages received by the artist.

The sub-database 133 may be formed to include a subscription information storage unit 1331 that stores information about fan users following an artist, and a message body storage unit 1332 that stores the contents of artist messages and fan messages.

An example interaction between the processor 140 and the database 130 that may occur in response to the private chat service being provided between an artist and a fan will now be described in more detail.

The processor 140 may receive a fan message generated from a first fan terminal among a plurality of fan terminals 200-2. The processor 140 may control the private chat service relay server 100 to store the fan message in the first individual database 1321 corresponding to the first fan terminal among the plurality of individual databases 1320. In some cases, the processor 140 may generate a message feed for the fan message and provide the message feed to the artist terminal 200-1 in a case that (or in response to) the fan message being stored in the first individual database 1321.

According to some embodiments, the processor 140 may receive an artist message from the artist terminal 200-1. In response to receiving the artist message, the processor 140 may control the private chat service relay server 100 to store the artist message and artist information in the DM-specific database 1310. In response to the artist message being stored in the DM-specific database 1310, the processor 140 may generate a message feed provided to the plurality of fan terminals 200-2 and transfer the message feed to, for instance, the first fan terminal.

In response to a private chat update being requested from the first fan terminal, the processor 140 may receive a message update request of a private chat from the first fan terminal. The processor 140 may generate a private message corresponding to the first fan terminal based on the artist message and fan account information corresponding to the first fan terminal. The processor 140 may transfer the fan message stored in the first individual database 1321 and the generated private message to the first fan terminal. The private message may mean or refer to a message in which specific words or keywords in the message are converted according to the reception entities. The message feed may include notifications or posts to notify the reception entities of the message of the receipt of the message.

In some implementations, in response to receiving an artist message, the processor 140 may store the artist message in the DM-specific database 1310 and may also convert the artist message into a private message and store the private message in the individual database 1320.

For example, the processor 140 may generate a plurality of private messages corresponding to each of the plurality of fan terminals 200-2 based on the artist message and fan account information corresponding to each of the plurality of fan terminals 200-2. The processor 140 may store a plurality of private messages in a corresponding individual database based on the fan account information. In response to the private message being completely stored in the individual database 1320, the processor 140 may control the private chat service relay server 100 to delete the artist message stored in the DM-specific database 1310. To this end, the processor may receive the private message from the individual database 1320 rather than the DM-specific database 1310 after the private message is stored in the individual database 1320 and transfer the private message to the fan terminal 200-2.

According to various embodiments, in response to an artist writing (or otherwise generating) a message, the private chat service relay server 100 may generate a corresponding private message for each subscriber fan and store the private message in the individual database allocated to each user, e.g., each subscriber fan. Accordingly, in response to a user request to check or update a message, the private chat service may be more quickly provided to a plurality of users by retrieving the message from the individual database 1320.

In some implementations, the processor 140 may store artist messages and artist information in the DM-specific database 1310, delete the artist messages stored in the DM-specific database 1310 in response to a preset reference time elapsing, receive a private message from the individual database 1320, and transfer the private message to the fan terminal.

The DM-specific database 1310 may be formed based on Not Only SQL (NoSQL), and the individual database 1320 may be formed based on Structured Query Language (SQL). It is contemplated, however, that any other suitable storage structure may be utilized in association with the DM-specific database 1310 and the individual database 1320.

The DM-specific database 1310 may have a non-relational database structure and may store unstructured data. The individual database 1320 may have a relational database structure and may generate a database (DB) table for each user and pre-apply a DB table filter for each user to store message data for each user.

In some cases, given that the individual database 1320 may be configured using SQL, the write speed may be slower and the read speed may be faster than the DM-specific database 1310. The DM-specific database 1310 may have a faster write speed and a slower read speed than the individual database 1320.

The private chat service relay server 100 may increase the speed of providing the private chat service to a plurality of users by providing private messages stored using the individual database 1320. Although private messages may be stored in the individual databases 1320, the operation during the time that messages are stored in the individual database 1320 may be supplemented by providing the private messages using the DM-specific database 1310.

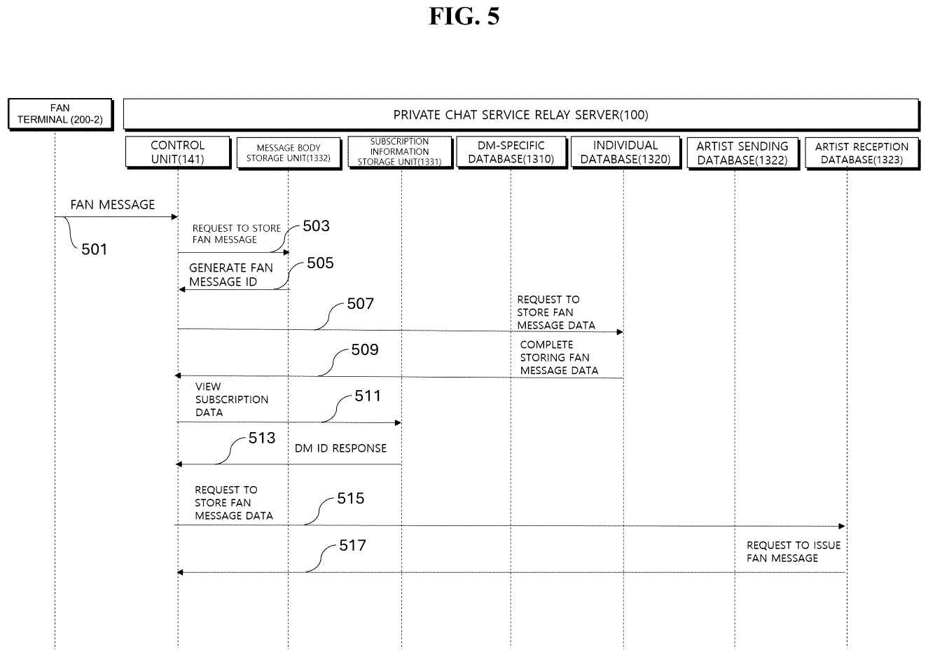

Example data processing processes between the processor 140 and the database 130 will now be described in more detail with reference to FIGS. 5 to 9 described below.

FIG. 5 is a schematic data flow diagram illustrating data processing for fan message storage according to an embodiment.

Referring to FIG. 5, in response to a fan user writing and transferring a fan message to be transferred to an artist, the fan message data may be transferred from the fan terminal 200-2 to the control unit 141 of the private chat service relay server 100 at 501. The fan message data may include at least one of message content, message reception entity artist information, and artist subscription information of a fan.

The control unit 141 may transfer the received fan message data to the message body storage unit 1332 and request the fan message data be stored in the message body storage unit 1332 per 503. The message body storage unit 1332 may store the fan message data, and in response to storage of the fan message data being complete, generate a fan message identity (ID) corresponding to the fan message and respond with the fan message ID to the control unit 141 in 505.

The control unit 141 that receives the fan message ID may, as part of 507, request storage of the fan message data in the individual database 1320. The individual database 1320 refers to a database allocated to each user. Accordingly, in response to a fan message being received at the first fan terminal, storage of the fan message data may be requested in the first individual database 1321 allocated to the first fan terminal. The fan message data stored in the individual database 1320 may include the fan message ID and subscription information.

In a case that the fan message data is stored in the individual database 1320, the individual database 1320 may transfer a fan message data storage completion response to the control unit 141 per 509.

The control unit 141 that receives the fan message data storage completion response from the individual database 1320 may request the subscription information storage unit 1331 to view the subscription information of a fan in 511. For example, the message queue unit (not shown) included in the control unit 141 may request subscription information view from the subscription information storage unit 1331 based on subscriber ID information of a fan.

The subscription information storage unit 1331 that receives a subscription information viewing request may respond, in 513, to the control unit 141 with a DM ID corresponding to the subscriber ID information. The DM ID may correspond to an ID of a private chat room or artist information.

The control unit 141 that receives the DM ID from the subscription information storage unit 1331 may request fan message data storage in the artist reception database 1323 of a reception entity artist of the fan message based on the DM ID at 515. The fan message data stored in the artist reception database 1323 may include the fan message ID and DM ID information.

In response to the storage of the fan message data in the artist reception database 1323 being complete, the artist reception database 1323 may respond to a fan message issuance request to the control unit 141 per 517.

The control unit 141 that receives the fan message issuance request from the artist reception database 1323 may generate a fan feed for an artist to be sent to the reception entity artist of the fan message, and transfer the fan feed for the artist to the terminal 200 of the reception entity artist.

Accordingly, in a case that a fan sends a message to an artist, the message of the fan may be stored in the reception database of the artist. In addition, in a case that an artist wants to check the fan feed for the artist to view fan messages, the private chat service relay server 100 may read the fan messages based on the fan message data stored in the artist reception database 1323 and provide the fan message to the artist terminal 200-1.

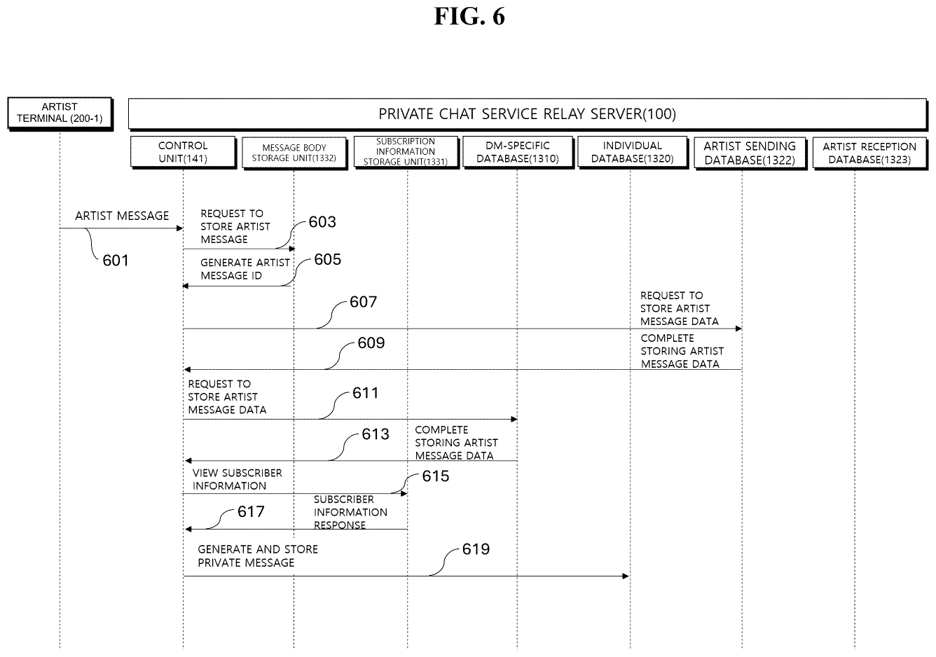

An example data processing sequence for storing artist messages will now be described with reference to FIG. 6.

FIG. 6 is a schematic data flow diagram illustrating artist message storage according to an embodiment.

Referring to FIG. 6, in a case that an artist user writes and transfers an artist message to be transferred to a fan user, the artist message data may be transferred from the artist terminal 200-1 to the control unit 141 of the private chat service relay server 100 per 601.

The artist message data may include at least one of the message content, message reception entity information, and DM ID.

The control unit 141 may transfer, in 603, the received artist message data to the message body storage unit 1332 and request the fan message data be stored in the message body storage unit 1332. The message body storage unit 1332 may store the artist message data, and in response to the storage of the artist message data being complete, may generate an artist message ID corresponding to the artist message and respond the artist message ID to the control unit 141 at 605.

The control unit 141 that receives the artist message ID may request the storage of artist message data in the artist sending database 1322 per 607. The artist sending database 1322 is the individual database allocated to an artist, and refers to a database in which messages written by the artist to be sent are stored. The artist sending database 1322 may be configured separately or integrated with the artist reception database 1323. The artist message data stored in the artist sending database 1322 may include data regarding one or more of the artist message ID and the DM ID.

In response to the artist message data being stored in the artist sending database 1322, the artist sending database 1322 may transfer an artist message data storage completion response to the control unit 141 in 609.

The control unit 141 that receives the artist message data storage completion response from the artist sending database 1322 may request the storage of artist message data in the DM-specific database 1310 per 611. The artist message data stored in the DM-specific database 1310 may include data regarding one or more of the artist message ID and the DM ID.

In response to the storage of artist message data in the DM-specific database 1310 being complete, the DM-specific database 1310 may transfer the artist message data storage completion response to the control unit 141 as part of 613.

The control unit 141 that receives the artist message data storage completion response from the DM-specific database 1310 may request, in 615, the subscription information storage unit 1331 to view subscriber list information corresponding to the DM ID. For example, the message queue unit (not shown) included in the control unit 141 may request a subscriber ID list subscribing to an artist based on the DM ID from the subscription information storage unit 1331.

In response to the control unit 141 receiving the subscriber ID list from the subscription information storage unit 1331, the control unit 141 may generate a private message for each subscriber based on the artist message data and the subscriber ID list per 617. The control unit 141 may request the storage of the private message corresponding to the individual database 1321 of each subscriber.

Requesting the storage of the private message in the individual database 1321 may include the control unit 141 storing the contents of the private message in the message body storage unit 1332 and requesting storage of data for one or more of a private message ID, DM ID, and subscriber ID received in response from the message body storage unit 1332.

In response to an artist sending a message to a fan, a private message for each fan may be stored in the individual database 1321 of the fan in 619. In a case that a fan wants to view a message, the private chat service relay server 100 may read the private message data stored in the individual database 1321 and provide the private message to the fan terminal 200-2.

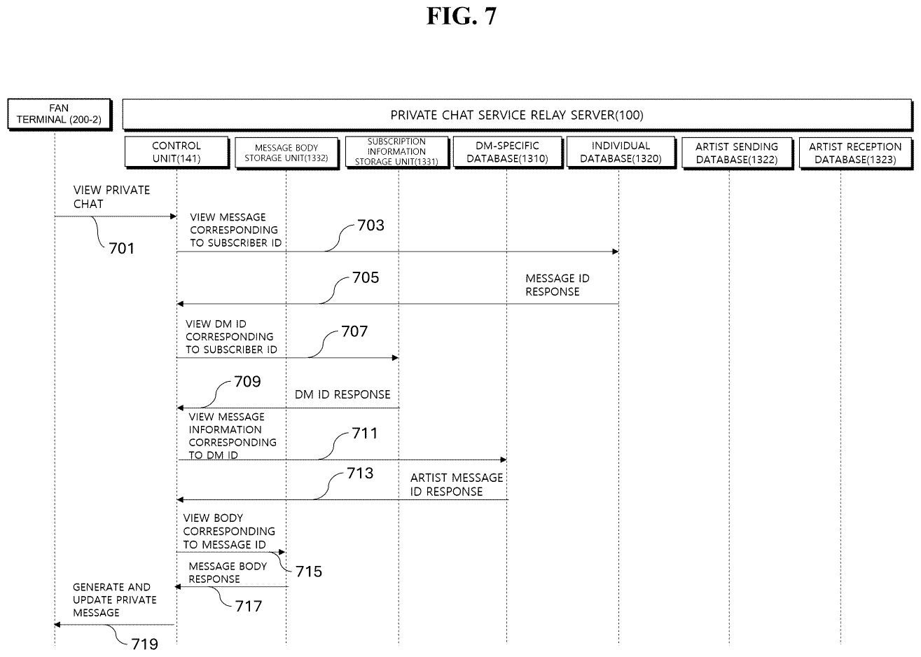

With reference to FIG. 7, an example data processing process in response to a fan user request to view a private chat before the private message is stored in the individual database 1320 will now be described in more detail.

FIG. 7 is a schematic data flow diagram illustrating private chat message viewing of a fan terminal according to an embodiment.

Referring to FIG. 7, in response to a fan request to view a private chat or artist message, the control unit 141 may receive, at 701, a private chat viewing request from the fan terminal 200-2. The private chat viewing request may include the subscriber ID information of the fan.

In response to the control unit 141 receiving the private chat viewing request from the fan terminal 200-2, the control unit 141 may request a message view corresponding to the subscriber ID to the individual database 1320 corresponding to the fan terminal 200-2 or a fan account per 703.

The individual database 1320 may respond with the stored message ID list in response to the message viewing request at 705. The message that the individual database 1320 responds to the control unit 141 may include one or more of the fan message ID and the private message ID. However, in some implementations, before the private message is stored in the individual database 1320, the message ID responded from the individual database 1320 to the control unit 141 may include only the fan message ID.

In some embodiments, the control unit 141 may request the subscription information storage unit 1331 to view the DM ID corresponding to the subscriber ID of a fan as part of 707. The subscription information storage unit 1331 that receives a DM ID viewing request may respond to the control unit 141 with the DM ID stored in response to the subscriber ID in 709.

The control unit 141 that receives the DM ID may request the DM-specific database 1310 to view a message corresponding to the DM ID at 711. The DM-specific database 1310 that receives the message viewing request may respond to the control unit 141 with the artist message ID stored in response to the DM ID per 713.

Accordingly, the control unit 141 may receive the fan message ID from the individual database 1320 and the artist message ID from the DM-specific database 1310 as part of 715. The control unit 141 may request, in 717, message body information corresponding to the fan message ID and the artist message ID from the message body storage unit 1332 based on the received fan message ID and artist message ID. Accordingly, the message body storage unit 1332 may respond with the message information corresponding to the received fan message ID and artist message ID.

The control unit 141 may transfer the received fan messages and artist messages to the fan terminal 200-2 per 719. The control unit 141 may convert the artist message into the private message based on the subscription information of the fan and transfer the same to the fan terminal 200-2.

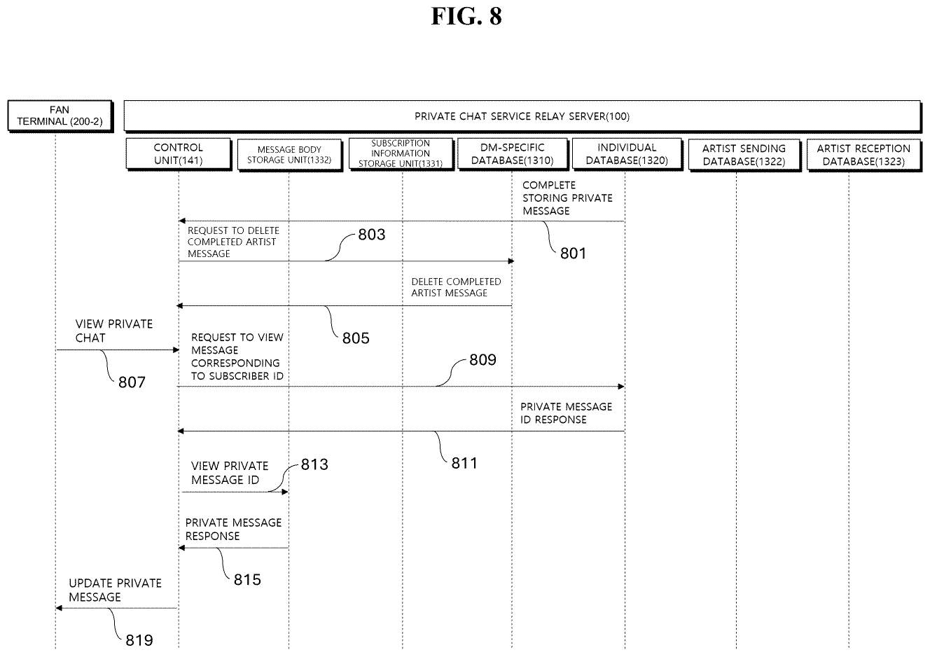

With reference to FIG. 8, an example data processing process in a case that a fan user requests to view a private chat after a private message has been stored in the individual database 1320 will now be described in more detail.

FIG. 8 is a schematic data flow diagram illustrating private chat message viewing of a fan terminal according to an embodiment.

Referring to FIG. 8, in response to the private message storage in the individual database 1320 being complete at 801, the control unit 141 may request to delete a completed artist message in the DM-specific database 1310 per 803. The completed artist message refers to an artist message or artist message ID that has been converted into a private message.

By deleting the artist message ID stored in the DM-specific database 1310, it is possible to prevent duplicate artist messages and private messages from being sent to the fan terminals 200-2. In some implementations, the DM-specific database 1310 may transmit a message to the control unit 141 informing the control unit 141 of the successful deletion of the completed artist message at 805.

After the deletion of the artist message ID from the DM-specific database 1310 is complete and in response to a request being made to view the private chat or artist message from the fan terminal 200-2, the control unit 141 may receive a request to view the private chat from the fan terminal 200-2 as part of 807. The private chat viewing request may include the subscriber ID information of the fan.

In response to the control unit 141 receiving the private chat viewing request from the fan terminal 200-2, the control unit 141 may request the individual database 1320 corresponding to the fan terminal 200-2 or fan account 200-2 to view a message corresponding to the subscriber ID per 809.

The individual database 1320 may respond with the message ID list stored in response to the message viewing request at 811. The message that the individual database 1320 responds to the control unit 141 may include both the fan message ID and the private message ID.

In some embodiments, the control unit 141 may receive the fan message ID and the private message ID from the individual database 1320. The control unit 141 may request the message body information corresponding to the fan message ID and private message ID from the message body storage unit 1332 based on the received fan message ID and private message ID in 813. Accordingly, the message body storage unit 1332 may respond with the message information corresponding to the received fan message ID and private message ID per 815.

The control unit 141 may transfer the received fan message and private message to the fan terminal 200-2 at 819. Accordingly, even in cases in which the private chat viewing is requested from the plurality of fan terminals 200-2, the private chat service relay server 100 may perform only the operation of reading messages from the individual database 1320 corresponding to the fan terminal 200-2. Accordingly, even in cases in which a plurality of users request message viewing, relatively fast processing speed may be achieved or otherwise maintained.

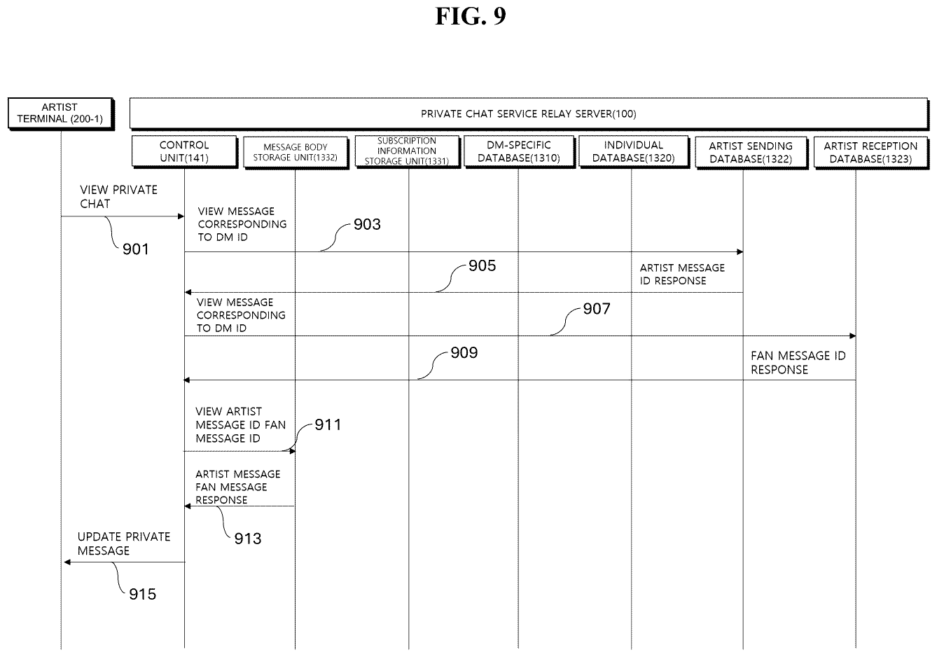

With reference to FIG. 9, an example data processing process in which an artist requests to view a private chat will now be described in more detail.

FIG. 9 is a schematic data flow diagram illustrating private chat message viewing of an artist terminal according to an embodiment.

Referring to FIG. 9, in a case that an artist requests to view a private chat, the control unit 141 may receive the private chat viewing request from the artist terminal 200-1 at 901. The private chat viewing request may include the DM ID information.

In response to the control unit 141 receiving the private chat viewing request from the artist terminal 200-1, the control unit 141 may request the artist sending database 1322 to view a message corresponding to the DM ID in 903. Accordingly, the artist sending database 1322 may respond with the stored artist message ID list corresponding to the DM ID of an artist per 905.

The control unit 141 may request the artist reception database 1323 to view a message corresponding to the DM ID in 907. Accordingly, the artist reception database 1323 may respond with the stored fan message ID list stored corresponding to the DM ID of the artist at 909.

The control unit 141 may receive an artist message ID list from the artist sending database 1322 in 905 and a fan message ID list from the artist reception database 1323 at 909. The control unit 141 may request message information viewing from the message body storage unit 1332 based on the received artist message ID list and fan message ID list per 911.

Accordingly, the message body storage unit 1332 may respond to the control unit 141 with message information corresponding to the artist message ID list and the fan message ID list in 913. The control unit 141 that receives artist message and fan message information updates the message content to the artist terminal 200-1 as part of 915.

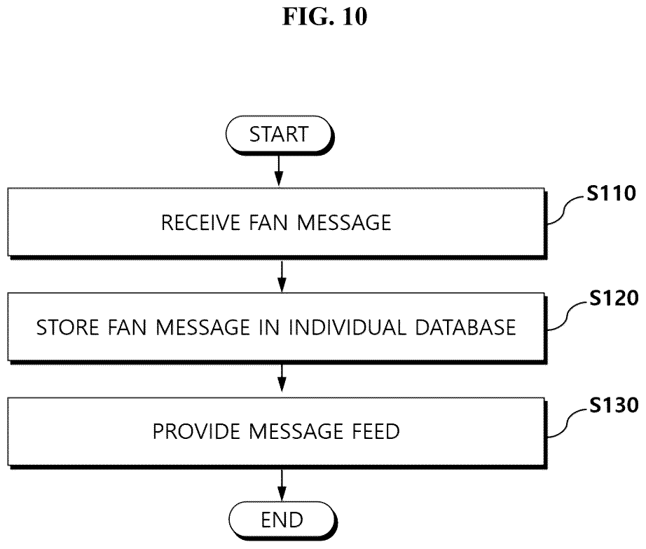

An example method for providing a private chat service will now be described in more detail with reference to FIGS. 10 to 14.

FIG. 10 is a schematic flowchart of a method for storing a fan message according to an embodiment.

Referring to FIG. 10, the method for storing the fan message sent by a fan user to an artist in the private chat service according to an embodiment may include: receiving a fan message (S110); storing the fan message (S120); and providing a message feed (S130).

For example, in the reception of the fan message (S110), in response to a fan user writing and transferring a fan message to be transferred to an artist, the fan message data may be transferred from the fan terminal 200-2 to the control unit 141 of the private chat service relay server 100. The fan message data may include at least one of the message content, message reception entity artist information, and artist subscription information of the fan.

In the storage of the fan message (S120), the control unit 141 may store the received fan message data in the individual database 1320. For instance, the control unit 141 may transfer the received fan message data to the message body storage unit 1332 and request the fan message data be stored in the message body storage unit 1332. The message body storage unit 1332 may store the fan message data, and in response to the storage of the fan message data being complete, may generate the fan message ID corresponding to the fan message and respond with the fan message ID to the control unit 141.

The control unit 141 that receives the fan message ID may request storage of the fan message data in the individual database 1320. The individual database 1320 means a database allocated to each user. Accordingly, in response to a fan message being received at the first fan terminal, storage of the fan message data may be requested in the first individual database 1321 allocated to the first fan terminal. The fan message data stored in the individual database 1320 may include the fan message ID and subscription information.

In the provision of the message feed (S130), the control unit 141 may generate a message feed to be transferred to the artist who is the reception entity of the fan message and transfer the message feed to the artist terminal 200. For example, in response to the fan message data being stored in the individual database 1320, the individual database 1320 may transfer the fan message data storage completion response to the control unit 141.

The control unit 141 that receives the fan message data storage completion response from the individual database 1320 may request the subscription information storage unit 1331 to view the subscription information of a fan. For instance, the message queue unit (not shown) included in the control unit 141 may request subscription information view from the subscription information storage unit 1331 based on subscriber ID information of a fan.

The subscription information storage unit 1331 that receives a subscription information viewing request may respond to the control unit 141 with the DM ID corresponding to the subscriber ID information. The DM ID may correspond to an ID of a private chat room or artist information.

The control unit 141 that receives the DM ID from the subscription information storage unit 1331 may request fan message data storage in the artist reception database 1323 of a reception entity artist of the fan message based on the DM ID. The fan message data stored in the artist reception database 1323 may include the fan message ID and DM ID information.

In response to the storage of the fan message data in the artist reception database 1323 being complete, the artist reception database 1323 may respond to a fan message issuance request to the control unit 141.

The control unit 141 that receives the fan message issuance request from the artist reception database 1323 may generate a fan feed for an artist to be sent to the reception entity artist of the fan message, and transfer the fan feed for the artist to the terminal 200 of the reception entity artist.

Accordingly, in a case that a fan sends a message to an artist, the message of the fan may be stored in the reception database of the artist. In a case that an artist wants to check the fan feed for the artist to view fan messages, the private chat service relay server 100 may read the fan messages based on the fan message data stored in the artist reception database 1323 and provide the fan message to the artist terminal 200-1.

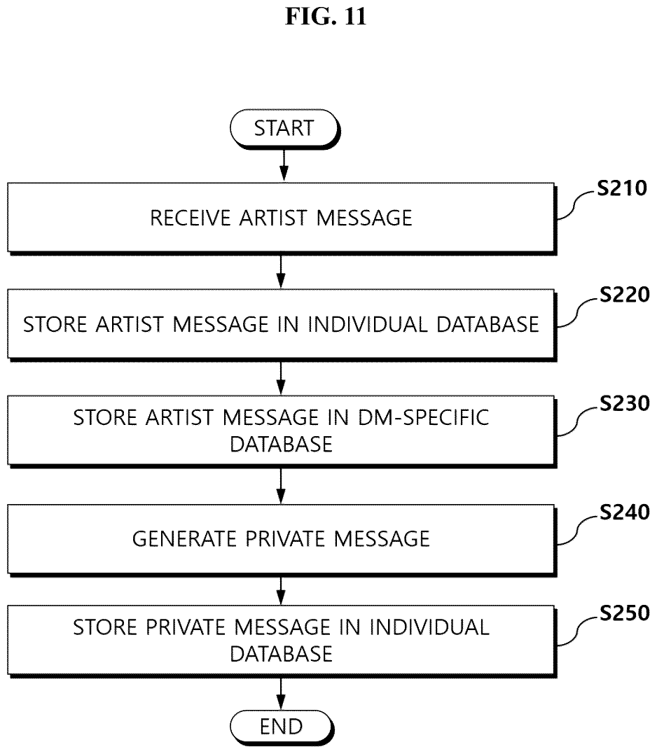

An example method for storing an artist message will now be described in more detail with reference to FIG. 11.

FIG. 11 is a schematic flowchart of a method for storing an artist message according to an embodiment.

Referring to FIG. 11, the method for storing the artist message may include: receiving an artist message (S210); storing the artist message in an individual database (S220); storing the artist message in a DM-specific database (S230); generating a private message (S240); and storing the private message (S250).

In the reception of the artist message (S210), in a case that an artist user writes and transfers an artist message to be transferred to a fan user, the artist message data may be transferred from the artist terminal 200-1 to the control unit 141 of the private chat service relay server 100. The artist message data may include at least one of the message content, message reception entity information, or DM ID.

In the storage of the artist message in the individual database (S220), the control unit 141 may store the received artist message data in the artist sending database 1322 among the individual databases 1320 of an artist.

For example, the control unit 141 may transfer the received artist message data to the message body storage unit 1332 and request the fan message data be stored in the message body storage unit 1332. The message body storage unit 1332 may store the artist message data, and in response to the storage of the artist message data being complete, may generate an artist message ID corresponding to the artist message and respond with the artist message ID to the control unit 141.

The control unit 141 that receives the artist message ID may request the storage of artist message data in the artist sending database 1322. The artist sending database 1322 is the individual database allocated to an artist, and refers to a database in which messages written by the artist to be sent are stored. The artist sending database 1322 may be configured separately or integrated with the artist reception database 1323. The artist message data stored in the artist reception database 1323 may include data regarding one or more of the artist message ID and the DM ID.

In response to the artist message data being stored in the artist reception database 1323, the artist reception database 1323 may transfer an artist message data storage completion response to the control unit 141.

In the storage of the artist message in the DM-specific database (S230), the control unit 141 may store the received artist message in the DM-specific database 1310.

For example, the control unit 141 may request the storage of the artist message data in the DM-specific database 1310. The DM-specific database 1310 may store the artist message or message ID by DM ID. The artist message data stored in the DM-specific database 1320 may include data regarding one or more of the artist message ID and DM ID.

In the generation of the private message (S240), the control unit 141 may generate a private message to be transferred to a fan user who subscribes to an artist based on the received artist message.

For instance, the control unit 141 that receives the artist message data storage completion response from the DM-specific database 1310 may request the subscription information storage unit 1331 to view subscriber list information corresponding to the DM ID. The message queue unit (not shown) included in the control unit 141 may request the subscriber ID list subscribing to an artist based on the DM ID from the subscription information storage unit 1331.

In response to the control unit 141 receiving the subscriber ID list from the subscription information storage unit 1331, the control unit may generate a private message for each subscriber based on the artist message data and the subscriber ID list.

In the storage of the private message (S250), the control unit 141 may store the generated private message in a corresponding individual database 1320.

For example, the private message may be generated for each fan user who subscribes to the artist. The individual database 1321 may be allocated to the each fan user.

Accordingly, the control unit 141 may store the generated private message in the individual database 1321 of each fan user.

Requesting the storage of the private message in the individual database 1321 may mean that the control unit 141 stores the contents of the private message in the message body storage unit 1332 and requests storage of data for one or more of a private message ID, DM ID, and subscriber ID received in response from the message body storage unit 1332.

In a case that an artist transmits a message to a fan, a private message for each fan may be stored in the individual database 1321 of the fan. In instances in which a fan wants to view a message, the private chat service relay server 100 may read the private message data stored in the individual database 1321 and provide the private message data to the fan terminal.

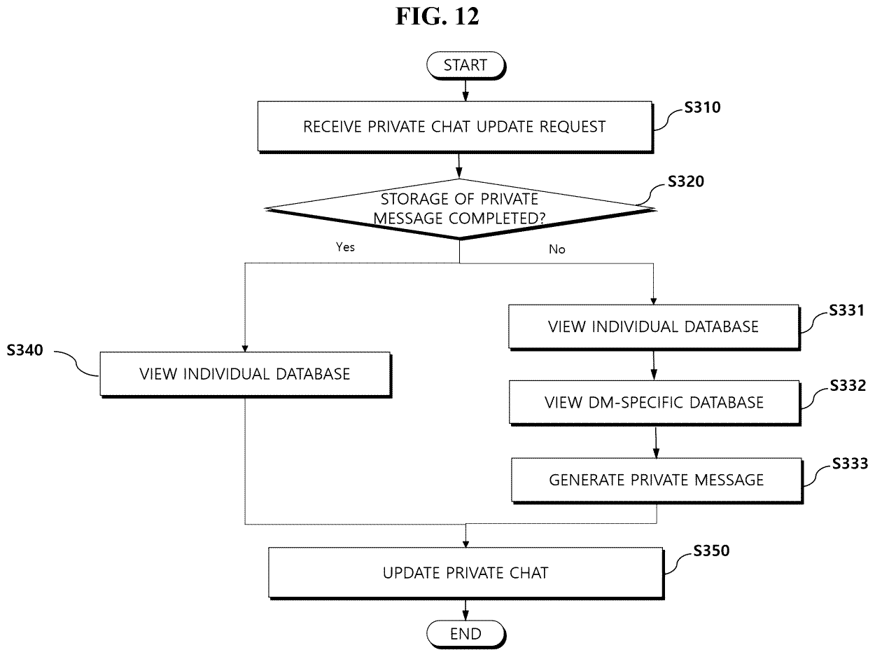

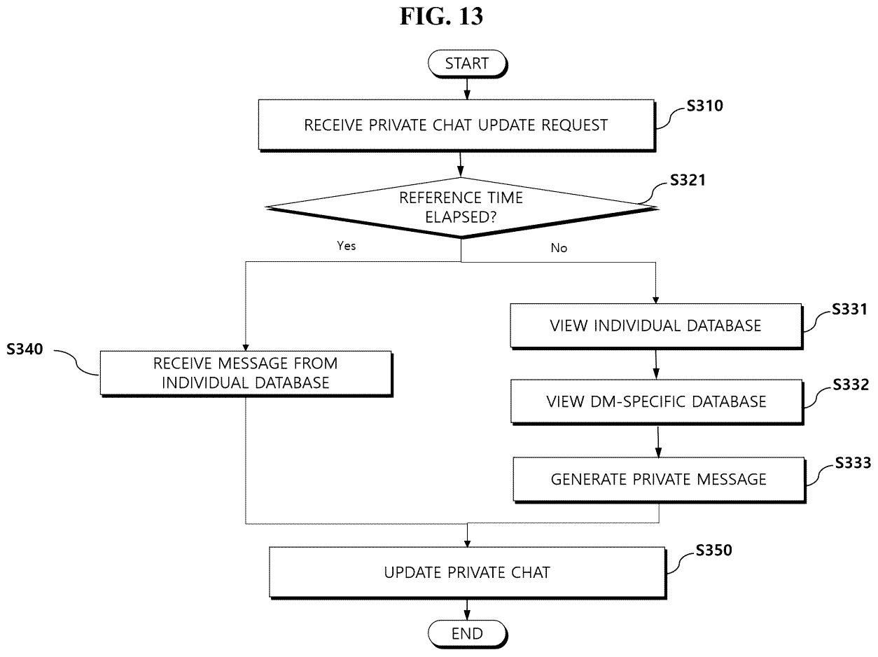

An example private chat update method for a fan user will now be described in more detail with reference to FIGS. 12 and 13.

FIGS. 12 and 13 are schematic flowcharts of private chat update methods of a fan terminal according to various embodiments.

Referring to FIG. 12, the private chat update method according to requests for updating and viewing a private chat of a fan may include: receiving a private chat update request (S310); checking storage of a private message (S320); viewing an individual database (S340); viewing a DM-specific database (S332); and updating the private chat (S350).

In the reception of the private chat update request (S310), in a case that a fan requests to view a private chat or artist message, the control unit 141 may receive a private chat viewing request from the fan terminal 200-2. The private chat viewing request may include the subscriber ID information of the fan.

In the checking of the storage of the private message (S320), the control unit 141 may check whether the private message is being stored in the individual database 1321 or whether storage has been completed.

In some implementations, while the private message is stored in the individual databases 1321, artist messages may be read from the DM-specific database 1310 rather than the individual database 1320 to update the private chat.

For example, in response to the private message not being stored in the individual database 1320 (e.g., the first individual database 1321), then viewing an individual database (S331), a viewing a DM-specific database (S332), and generating a private message (S333) may be performed.

In the viewing of the individual database (S331), the control unit 141 may request the individual database 1320 corresponding to the fan terminal 200-2 or the fan account to view a message corresponding to the subscriber ID.

The individual database 1320 may respond with the message ID list stored in response to the message viewing request. The message that the individual database 1320 responds with to the control unit 141 may include at least one of the fan message ID and the private message ID. However, before the private message is stored in the individual database 1320, the message ID responded from the individual database 1320 to the control unit 141 may include only the fan message ID. Accordingly, in the viewing of the individual database (S331), the fan message data written by a fan may be received.

In the DM-specific database viewing stage (S332), the control unit 141 may request the subscription information storage unit 1331 to view the DM ID corresponding to the subscriber ID of the fan. The subscription information storage unit 1331 that receives the DM ID viewing request may respond to the control unit 141 with the DM ID stored in response to the subscriber ID.

The control unit 141 that receives the DM ID may request the DM-specific database 1310 to view a message corresponding to the DM ID. The DM-specific database 1310 that receives the message viewing request may respond to the control unit 141 with the artist message ID stored in response to the DM ID.

Accordingly, the control unit 141 may receive the fan message ID from the individual database 1320 and the artist message ID from the DM-specific database 1310. The control unit 141 may request message body information corresponding to the fan message ID and the artist message ID from the message body storage unit 1332 based on the received fan message ID and artist message ID. Accordingly, the message body storage unit 1332 may respond with the message information corresponding to the received fan message ID and artist message ID.

The control unit 141 may transfer the received fan messages and artist messages to the fan terminal 200-2.

In the generation of the private message (S333), the control unit 141 may convert the artist message into the private message based on the subscription information of the fan and transfer the private message to the fan terminal 200-2.

In response to the private message storage in the individual database 1320 being completed in the checking of the storage of the private message (S320), only the viewing of the individual database (S340) may be performed to update the private chat of the fan.

In the viewing of the individual database (S340), the control unit 141 may request to delete the completed artist message from the DM-specific database 1310. The completed artist message refers to an artist message or artist message ID that has been converted into a private message.

By deleting the artist message ID stored in the DM-specific database 1310, it is possible to prevent duplicate artist messages and private messages from being sent to the fan terminals 200-2.

In response to the deletion of the artist message ID from the DM-specific database 1310, a request may be made to view the private chat or artist message from the fan terminal 200, and in the viewing of the individual database (S340), the control unit 141 may request the individual database 1320 corresponding to the fan terminal 200-2 or the fan account to view a message corresponding to the subscriber ID.

The individual database 1320 may respond with the message ID list stored in response to the message viewing request. The message that the individual database 1320 responds to the control unit 141 may include both the fan message ID and the private message ID.

Accordingly, the control unit 141 may receive the fan message ID and the private message ID from the individual database 1320. The control unit 141 may request the message body information corresponding to the fan message ID and private message ID from the message body storage unit 1332 based on the received fan message ID and private message ID. The message body storage unit 1332 may respond with the message information corresponding to the received fan message ID and private message ID.

In the updating of the private chat (S350), the control unit 141 may transfer the received fan message and private message to the fan terminal 200-2 to update the private chat of the fan terminal 200-2.

Accordingly, even in instances in which the viewing of the private chat is requested from the plurality of fan terminals 200-2, the private chat service relay server 100 may perform only the operation of reading messages from the individual database 1320 corresponding to the fan terminal 200-2. Accordingly, even in cases in which a plurality of users request message viewing, relatively fast processing speed may be maintained.

The private chat update method of the fan terminal 200-2 according to an embodiment may be applied by changing the checking of the storage of the private chat (S320) to checking an elapse of a reference time (S321), such as will be described in association with FIG. 13.

Adverting to FIG. 13, in the checking of the elapse of the reference time (S321), the control unit 141 may determine that the private message is being stored in the individual database 1321 before a preset standard time elapses. Accordingly, in response to requesting an update of the private chat from the fan terminal 200-2 before a preset reference time elapses after receiving the artist message, the control unit 141 may perform the viewing of the individual database (S331), the viewing of the DM-specific database (S332), and the generation of the private message (S333).

For example, the control unit 141 may retrieve the artist message information stored in the DM-specific database 1310 before a preset reference time elapses after receiving the artist message, and may generate the private message based on the artist message and provides the same to the fan terminal 200.

In the checking of the elapse of the reference time (S321), the control unit 141 may determine that the private message has been completely stored in the individual database 1321 in a case that a preset reference time has elapsed. Accordingly, the control unit 141 may receive the artist message and, after a preset time has elapsed, may perform receiving a message (S340) in the individual database in response to the fan terminal 200 requesting an update of the private chat.

For instance, after a preset reference time has elapsed in response to reception of the artist message, the control unit 141 may provide the fan message and private message stored in the individual database 1320 to the fan terminal 200-2.

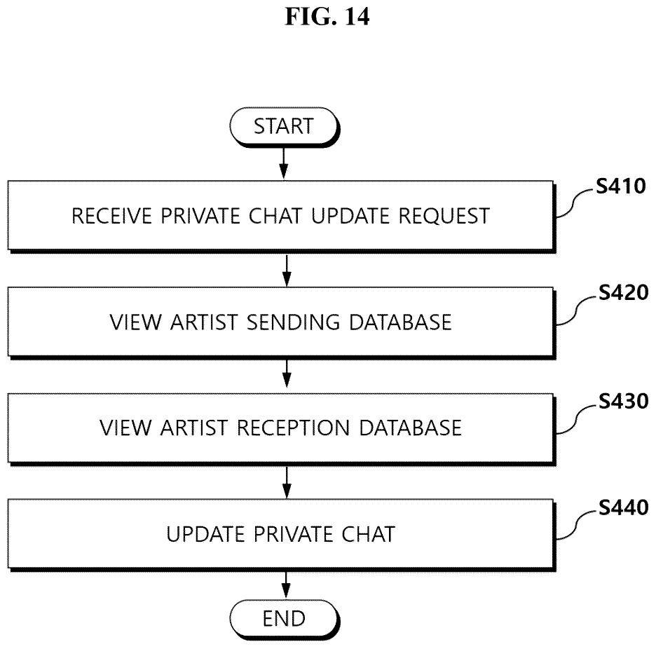

Referring to FIG. 14, an example private chat update method in a case that an artist requests a private chat viewing will now be described in more detail.

FIG. 14 is a schematic flowchart of a private chat update method of an artist terminal according to an embodiment.

Referring to FIG. 14, the private chat update method of the artist terminal 200-1 may include: receiving a private chat update request (S410), viewing an artist sending database (S420), viewing an artist reception database (S430), and updating a private chat (S440).

In response to an artist requesting to view the private chat in the reception of the private chat update request (S410), the control unit 141 may receive a private chat viewing request from the artist terminal 200-1. The private chat viewing request may include the DM ID information.

In the viewing of the artist sending database (S420), the control unit 141 may request the artist sending database 1322 to view a message corresponding to the DM ID. Accordingly, the artist sending database 1322 may respond with the stored artist message ID list corresponding to the DM ID of an artist.

In the viewing of the artist reception database (S430), the control unit 141 may request the artist reception database 1323 to view a message corresponding to the DM ID. Accordingly, the artist reception database 1323 may respond with the stored fan message ID list stored corresponding to the DM ID of the artist.

In some implementations, the control unit 141 may receive an artist message ID list from the artist sending database 1322 and a fan message ID list from the artist reception database 1323. The control unit 141 may request message information viewing from the message body storage unit 1332 based on the received artist message ID list and fan message ID list.

The message body storage unit 1332 may respond to the control unit 141 with message information corresponding to the artist message ID list and the fan message ID list. In the updating of the private chat (S440), the control unit 141 that receives artist message and fan message information may update the message content to the artist terminal 200-1.

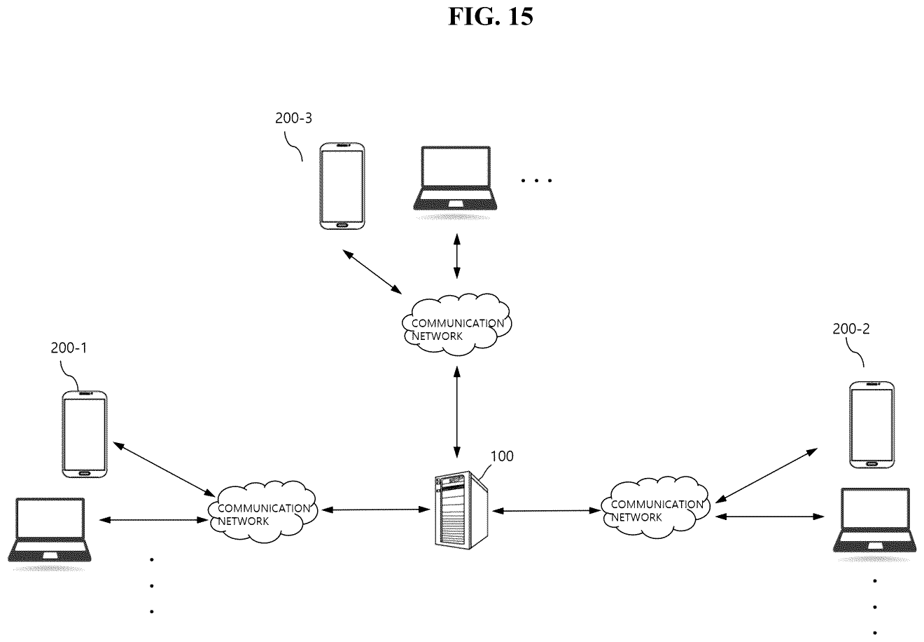

An example artist message review method will now be described in more detail with reference to FIGS. 15 to 20.

FIG. 15 is a schematic diagram illustrating a communication connection of a device for providing a private chat service for reviewing artist messages according to an embodiment.

Referring to FIG. 15, a device for providing the private chat service for adding an artist message review function may additionally connect a reviewer terminal 200-3 to the device for providing the private chat service illustrated in FIG. 1.

In addition to the communication connection between the private chat service relay server 100 and the artist terminal 200-1 and the fan terminal 200-2 described with reference to FIG. 1, the reviewer terminal 200-3 may be communicatively connected to the private chat service relay server 100 through the communication network.

The reviewer terminal 200-3 may refer to a terminal used by a reviewer set or otherwise configured to perform a review of an artist message before the artist message generated from the artist terminal 200-1 is transferred to the fan terminal 200-2.

In a case that a message is written and sent from the artist terminal 200-1, the written artist message may be first transferred to the reviewer terminal 200-3 before being transferred to the fan terminal 200-2. A reviewer may check the content of the artist message written by an artist using the reviewer terminal 200-3, and may select and input whether to approve sending, reject sending, or amend the artist message.

In response to the reviewer terminal 200-3 approving the sending of an artist message, the artist message may be converted into a private message and transferred to the fan terminal 200-2, which is a reception entity. The same message transmission and reception processing process as described above with reference to FIGS. 4 to 14 may be performed.

In cases in which the reviewer terminal 200-3 rejects the sending of an artist message, the artist message may be deleted and not transferred to the fan terminal 200-2, which is a reception entity. A message sending rejection message may be generated and provided to the artist terminal 200-1.

In response to a reviewer amending an artist message or inputting an amended message using the reviewer terminal 200-3, the amended message may be converted into a private message and transferred to the fan terminal 200-2, which is a reception entity. The message transmission and reception processing described in association with FIGS. 4 to 14 described above may be performed using the amended message instead of the artist message.

To perform the artist message review function, the processor 140 or the control unit 141 may additionally perform the various operations described herein.

The processor 140 may receive an artist message to be transferred from the artist terminal 200-1 to the fan terminal 200-2. In response to receiving the artist message, the processor 140 may transfer the artist message to a preset reviewer terminal 200-3. The processor 140 may wait for sending of the artist message to the fan terminal 200-2 until the reviewer terminal 200-3 approves the sending of the artist message.

In response to the reviewer terminal 200-3 approving the sending of an artist message, the processor 140 may store the artist message in the private chat relay server 100, convert the artist message stored in the private chat relay server 100 into a private message, and transfer the private message to the fan terminal 200-2.

In some embodiments, the processor 140 may store the artist message and artist information in the artist sending database 1322 and generate and provide the message feed provided to the reviewer terminal 200-3. In a case that the reviewer terminal 200-3 requests a review request message view, the processor 140 may receive the artist message and artist information from the artist sending database 1322, generate a review message based on the artist message and artist information, and transfer the review message to the reviewer terminal 200-3. In some instances, the artist message and artist information may also be provided to the reviewer terminal 200-3.

The processor 140 may generate a text message containing the content of the artist message and a link for selecting whether to approve sending the artist message, and transfer the artist message and the link to the reviewer terminal 200-3.

In some implementations, the processor 140 may generate a message containing the content of the artist message and a link for selecting whether to approve sending the artist message, and transfer the same to the reviewer terminal 200-3. The message may mean a message of applications (e.g., all applications) used to transmit and receive the message.

As part of rejecting the sending of an artist message from the reviewer terminal 200-3, the processor 140 may delete the artist message stored in the artist sending database 1322. The processor 140 may generate a sending rejecting message of the artist message and transfers the rejecting message to the artist terminal 200-1.

According to some embodiments, the processor 140 may receive an amended message for the artist message from the reviewer terminal 200-3. In response to the processor 140 receiving the amended message, the processor 140 may store the amended message in the private chat relay server 100, convert the amended message into a private message, and transfer the amended message to the fan terminal 200-2.

The method of converting the artist message or amended message into the private message and transferring the converted artist message or amended message to the fan terminal 200-2 may be the same as described above with reference to FIGS. 4 to 14.

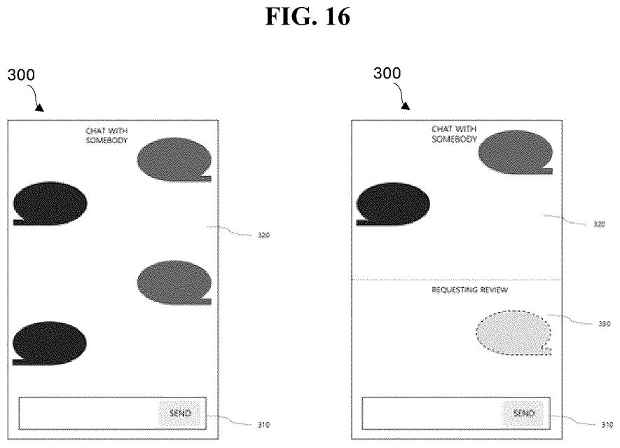

An example interface of the artist terminal 200-1 for reviewing artist messages will now be described in more detail with reference to FIG. 16.

FIG. 16 is a schematic diagram illustrating an interface of the artist terminal according to an embodiment.

As illustrated in FIG. 16, a private chat interface 300 of the artist terminal 200 may include a message input area 310 for writing an artist message and a message display area 320 for displaying a message that has been completed for delivery between a fan and an artist.

In a case that an artist inputs and sends an artist message in the message input area 310, the artist message may be transferred to a fan who is the other party in a private chat.

Messages received from fans who are the other party in the private chat may be displayed on the left side of the message display area, and messages sent by the artist to fans may be displayed on the right side of the message display area, or vice versa. Messages may be displayed in chronological order from top to bottom, and the colors of fan messages and artist messages may be distinguished.

In some embodiments, in a case that an artist inputs and sends an artist message in the artist message input area 310, a review request message display area 330 may be generated. The review request message display area 330 may refer to an area where an artist message being reviewed on the reviewer terminal 200-3 is displayed before the artist message is sent to a fan.

The review request message display area 330 may be distinguished from the message display area 320 in terms of color, transparency, and/or pop-up window. In some implementations, in the case of a review request message displayed in the review request message display area 330, it may be distinguished from a transferred message displayed in the message display area 320 by displaying the same as a semi-transparent message.

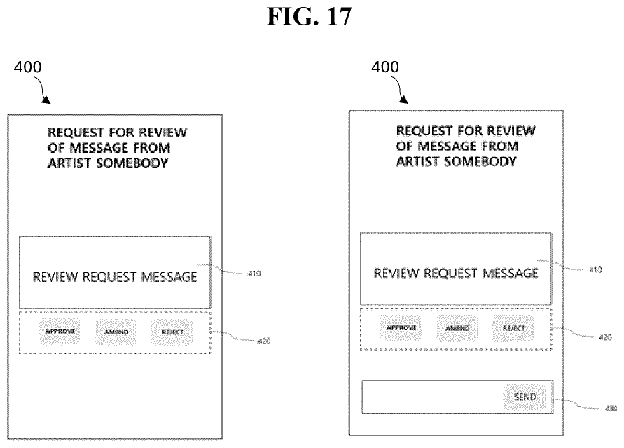

An example interface of the reviewer terminal 200-3 for reviewing artist messages will now be described in more detail with reference to FIG. 17.

FIG. 17 is a schematic diagram illustrating an interface provided to a reviewer terminal according to an embodiment.

As illustrated in FIG. 17, the private chat interface 400 of the reviewer terminal 200-3 may include a review request message display area 410 and a review approval selection area 420.

In response to an artist message being sent from the artist terminal 200-1, the artist message may be transferred to the reviewer terminal 200-3 before being transferred to the fan terminal 200-1. The artist message transferred to the reviewer terminal 200-3 may be displayed in the review request message display area 410. The review request message display area 410 may display one or more of the content of the artist message, artist information, time taken for writing a message, and the content of fan messages received before the artist message was written.

The review approval selection area 420 refers to an area that displays choices so that a reviewer may select and input one of the values of approval, amendment, and rejection. The reviewer may respond to a review request message by selecting one of the values displayed in the review approval selection area 420.

In cases in which a reviewer selects an amendment in the review approval selection area 420, an amendment message input area 430 may be generated in the private chat interface 400 of the reviewer terminal 200-3.

A reviewer may input an amendment message to be sent on behalf of the received review request message (artist message) using the amendment message input area 430. In response to the reviewer inputting and sending the amendment message, the amendment message may be converted into a private message and transferred to the fan terminal 200-2 instead of the artist message.

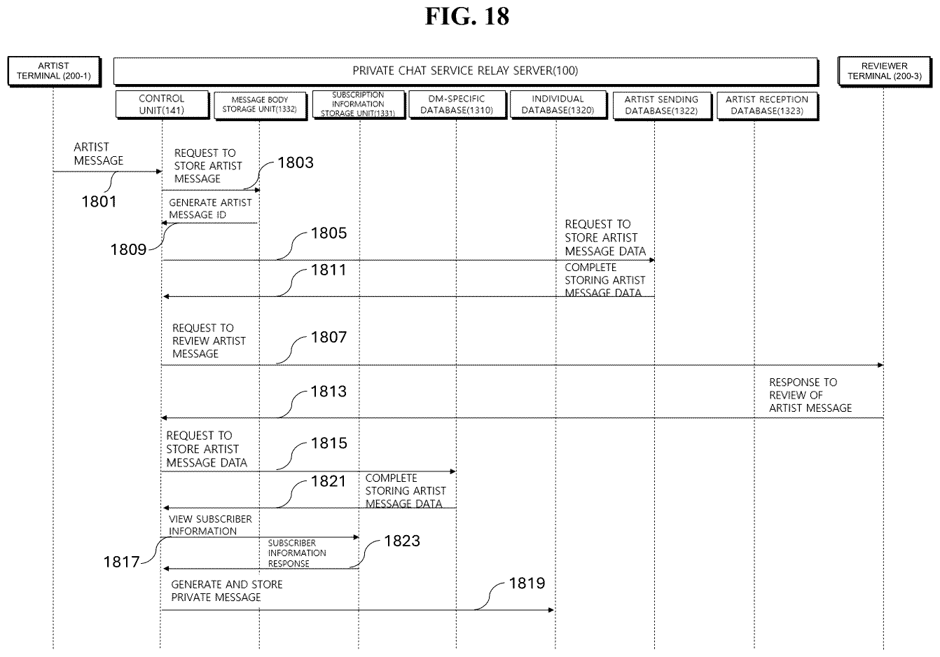

An example data processing process for reviewing artist messages will now be described in more detail with reference to FIG. 18.

FIG. 18 is a schematic data flow diagram illustrating an artist message review according to an embodiment.

Referring to FIG. 18, in addition to the artist message storage process described with reference to FIG. 6, an artist message review request stage and an artist message review response stage for artist message review may be additionally performed.

For example, in a case that the control unit 141 receives an artist message from the artist terminal 200 in 1801, transfers received artist message data to the message body storage unit 1332 for storage at 1803, and stores the artist message in the artist sending database 1322 per 1805, the control unit 141 may request the reviewer terminal 200-3 to review the artist message as part of 1807. It is noted, however, that the message body storage unit 1332 may store the artist message data, and in response to the storage of the artist message data being complete, may generate an artist message ID corresponding to the artist message and respond with the artist message ID to the control unit 141 at 1809. In response to the artist message data being stored in the artist sending database 1322, the artist sending database 1322 may transfer an artist message data storage completion response to the control unit 141 in 1811.

In some implementations, the control unit 141 may generate a message feed to notify a review request for the artist message and transfer the message feed to the reviewer terminal 200-3. The reviewer terminal 200-3 that receives an artist message review request may display a signed private chat interface 400, such as described with reference to FIG. 17. A reviewer may review the contents of the artist message displayed via the review request message display area 410. A determination of whether to approve the review of the artist message may be responded by selecting one of the values displayed via the review approval selection area 420.

In a case that the control unit 141 receives an artist message review response from the reviewer terminal 200-3 per 1813, the review response may include one of the values of artist message sending approval, artist message amendment, and artist message sending rejection.

In response to the control unit 141 receiving the artist message sending approval from the reviewer terminal 200-3 as a review response, the control unit 141 may convert the artist message into a private message and transfer the private message to the fan terminal 200-2. Accordingly, the control unit 141 may store artist message in the DM-specific database 1310 at 1815, view subscriber information using the subscription information storage unit 1331 per 1817, generate a private message, and store the private messages in the individual database 1320 as part of 1819.

In response to the storage of artist message data in the DM-specific database 1310 being complete, the DM-specific database 1310 may transfer the artist message data storage completion response to the control unit 141 as part of 1821. The control unit 141 may receive, per 1823, a subscriber ID list from the subscription information storage unit 1331 as part of viewing the subscriber information.

According to embodiments in which the control unit 141 receives the artist message sending rejection from the reviewer terminal 200 as a review response, the control unit 141 may delete the artist message stored in the artist sending database 1322. The control unit 141 may generate a sending rejection message including content on the artist message sending rejection and transfer the sending rejection message to the artist terminal 200-1.

In implementations in which the control unit 141 receives an amended message as a review response from the reviewer terminal 200-3, the control unit 141 may convert the amended message into a private message instead of the artist message and transfer the amended message to the fan terminal 200-2. The control unit 141 may store the amended message in the DM-specific database 1310 at 1815, view subscriber information using the subscription information storage unit 1331 per 1817, generate a private message, and store the private message in the individual database 1320 as part of 1819.

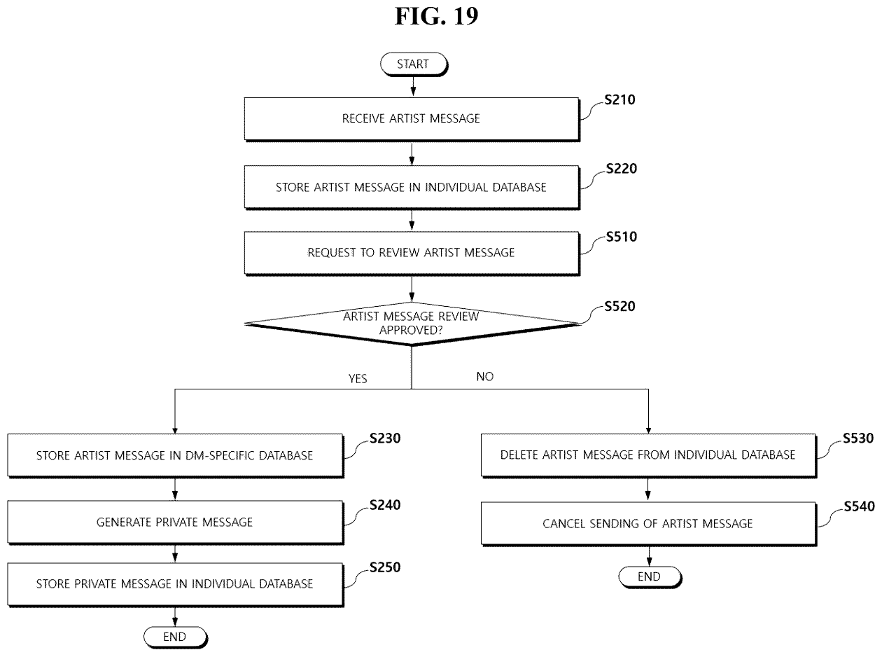

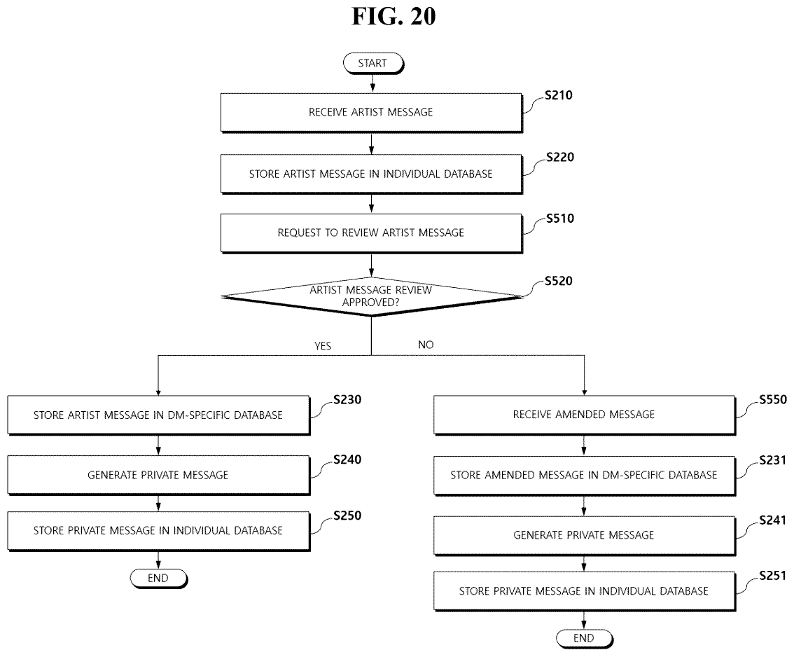

An example artist message review method will now be described in more detail with reference to FIGS. 19 and 20.

FIG. 19 is a schematic flowchart of an artist message review method according to an embodiment. FIG. 20 is a schematic flowchart of an artist message review method according to an embodiment.

Referring to FIG. 19, the method for reviewing an artist message may further include requesting an artist message review (S510) and checking an artist message review approval (S520) in addition to the artist message storage method described with reference to FIG. 5.

For example, the reception of the artist message (S210) and the storage of the artist message in the individual database (S220) may be performed identically as described above with reference to FIG. 5. In response to an artist message being sent from the artist terminal 200-2, the control unit 141 may receive the artist message and store the artist message in the artist sending database 1322.

In the requesting of the artist message review (S510), the control unit 141 may transfer the artist message to the preset reviewer terminal 200-3. The control unit 141 may wait for sending of the artist message to the fan terminal 200-2 until the reviewer terminal 200-3 approves the sending of the artist message.

The control unit 141 may generate a text message containing the content of the artist message and a link for selecting whether to approve sending the artist message, and transfer the text message and the link to the reviewer terminal 200-3.

In some implementations, the control unit 141 may generate a message including the content of the artist message and a link for selecting whether to approve sending the artist message, and transfer the message and link to the reviewer terminal 200-3. The message may mean a message of applications (e.g., all applications) used to transmit and receive the message.

As part of checking the artist message review (S520), the control unit 141 may receive a response to review approval from the reviewer terminal 200-3. In response to the reviewer terminal 200-3 responding with approval for sending an artist message, the storage of the artist message in the DM-specific database (S230), the generation of the private message (S240), and the storage of the private message in the individual database (S250) may be performed.

In some implementations, as part of checking the artist message review (S520), in response to the control unit 141 receiving a rejection of approval as a response, the control unit 141 may perform deleting an artist message (S530) and cancelling sending of the artist message (S540).

In the deletion of the artist message (S530), the control unit 141 may delete the artist message data stored in the artist sending database 1322. In the cancellation of the sending of the artist message (S540), the control unit 141 may generate a sending rejection message including the content regarding the artist message sending rejection and transfer the sending rejection message to the artist terminal 200-1.

In cases in which an amended message is input from the reviewer terminal 200-3 as illustrated in FIG. 20, the amended message may be transferred to the fan terminal 200-2.

As illustrated in FIG. 20, the artist message review method may further include receiving an amended message (S550).

In the reception of the amended message (S550), the control unit 141 may receive an amended message from the reviewer terminal 200-3 in response to the artist message review and may store the amended message in the DM-specific database (S231), generate a private message (S241), and store the private message in the individual database (S251). In this manner, the amended message may be converted into the private message and stored instead of the artist message.

In the storage of the amended message in the DM-specific database (S231), the control unit 141 may store the received amended message in the DM-specific database 1310.

For example, the control unit 141 may request the storage of amended message data in the DM-specific database 1310. The storage of the amended message in the DM-specific database 1310 (S231) may include requesting storage of an amended message in the message body storage unit 1332 and receiving an amended message ID as a response.

The DM-specific database 1310 may store the amended message or amended message ID for each DM ID. The amended message data stored in the DM-specific database 1310 may include data regarding at least one of the amended message ID and the DM ID included in the artist message.

In the generation of the private message (S241), the control unit 141 may generate a private message to be transferred to a fan user who subscribes to an artist based on the received amended message.

For example, the control unit 141 that receives a response of completion of storing the amended message data from the DM-specific database 1310 may request the subscription information storage unit 1331 to view subscriber list information corresponding to the DM ID. The message queue unit (not shown) included in the control unit 141 may request the subscriber ID list subscribing to an artist based on the DM ID from the subscription information storage unit 1331.

In response to the control unit 141 receiving the subscriber ID list from the subscription information storage unit 1331, the control unit 141 may generate a private message for each subscriber based on the amended message data and the subscriber ID list.

In the storage of the private message (S251), the control unit 141 may store the generated private message in a corresponding individual database 1320.

For example, the private message may be generated for each fan user who subscribes to the artist. As previously mentioned, the individual databases (such as the first individual database 1321) may be respectively allocated to the fan users. Accordingly, the control unit 141 may store the generated private message in the individual database 1320 of each fan user.

In a case that an artist sends a message to a fan according to the artist message review method described above, a reviewer may review an artist message and then determine whether to send the artist message and whether to amend the artist message. By reviewing the artist message, erroneous sending or mistakes in artist messages may be prevented.

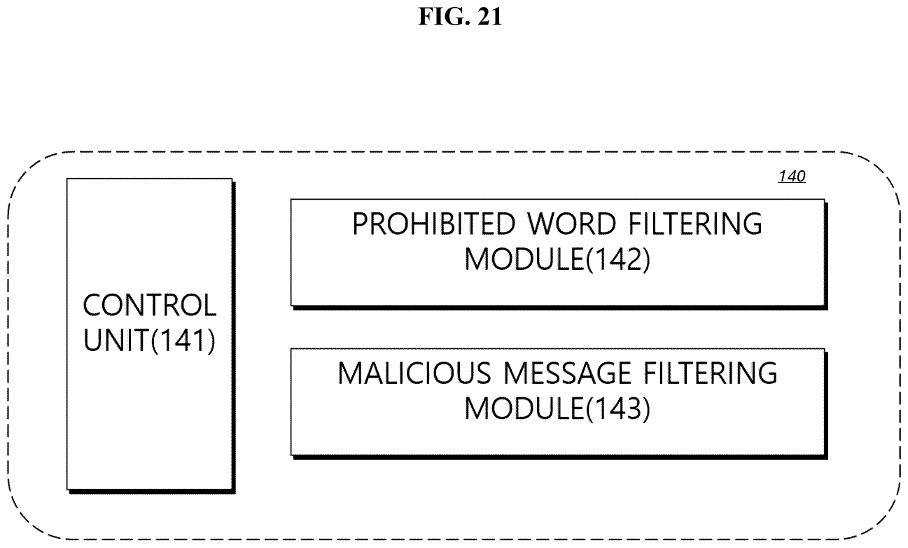

Example artist message and fan message filtering methods will now be described in more detail with reference to FIGS. 21 to 25.

FIG. 21 is a schematic block diagram illustrating functions of a processor according to an embodiment.

Referring to FIG. 21, the processor 140 may include, in addition to the functions of the control unit 141 described above, a prohibited word filtering module 142 for filtering artist messages and fan messages, and a malicious message filtering module 143 for filtering malicious messages.

The prohibited word filtering module 142 may determine whether artist messages and fan messages contain preset prohibited content, such as words, images, imagery, phrases, signs, symbols, etc. For descriptive convenience, it will be assumed that the predetermined prohibited content is predetermined prohibited words. The prohibited words may be set individually for each artist and fan. It is also contemplated that the prohibited words may be set based on groups of artists, groups of fans, etc. For fans, the prohibited words may be set differently depending on the message reception entity artist.

The prohibited word filtering module 142 may identify words included in artist messages and fan messages and may determine whether the identified words correspond to preset prohibited words.

In some implementations, the prohibited word filtering module 142 may convert fan message and artist message data into image data. The prohibited word filtering module 142 may derive or otherwise determine text corresponding to the converted image data.

The prohibited word filtering module 142 may identify words included in the text derived from an image and determine whether the identified words correspond to prohibited words, thereby performing prohibited word filtering of artist messages and fan messages.

The prohibited word filtering module 142 may convert artist message data and fan message data into image data using a convolution neural network (CNN) learning model.

For example, the prohibited word filtering module 142 may convert the text corresponding to the image data into, for instance, Korean consonants and vowels, respectively, upon derivation. It is contemplated, however, that any other suitable language may be utilized other than or in addition to Korean. For descriptive convenience, it will be assumed that the language is Korean. As an operational example, in response to an artist message or fan message containing content, such as “ [symbol] ” or “ [symbol] ,” the prohibited word filtering module 142 may convert the message into an image to derive the consonants “ [symbol] ” and “ [symbol] ”, and the vowels “ [symbol] ” and “ [symbol] ” A combination of vowels and consonants, such as “ [symbol] ” which means “shit” in English and “ [symbol] ” which means “fuck” in English may be derived as text.

In some embodiments, the CNN may be configured of or include a portion that extracts features of an image and a portion that classifies the image in a way that effectively recognizes and emphasizes the features from adjacent images while maintaining spatial information of the image. A feature extraction region may be configured of a convolution layer that finds features of an image while minimizing the number of shared parameters using a filter, and a pooling layer that strengthens and collects the features. Given that it may be possible to retrain and use the CNN for new (or other) recognition tasks based on existing networks, CNN-trained models may filter out new malicious messages that are creatively modified to avoid prohibited words, such as substituting numbers or symbols for characters or letters, spacing or breaking up words, using phonetic or foreign language variants, intentionally misspelling words, deriving creative plays on words, employing emojis and/or visual substitutions, employing code words, slang, and/or inside jokes, etc.

In some implementations, the prohibited word filtering module 142 may filter whether a prohibited word is included in the text derived using a bidirectional encoder representations from transformers (BERT) learning model. The BERT learning model may be fine-tuned using the accuracy of the determination results.

The BERT learning model is a pre-trained learning model that Google uses to label and train on a large number of articles on the web (or Internet) using semi-supervised learning. The BERT learning model may be used in the embedding process associated with performing tasks, such as named entity recognition and text classification.

As a method for determining whether a prohibited word is included by the prohibited word filtering module 142, a method using an algorithm that labels a message containing a vocabulary preset by a user or a determination method based on a preset reference may be used.

The preset reference may be categorized into expressions that include at least one of general profanity, vulgarity, and degrading expressions that are offensive to others, sexually provocative expressions, expressions that involve physical threats, expressions of discrimination based on region/race/country/religion/sexual orientation, derogatory expressions that cause humiliation and/or shame to others, and any other suitable categorization.

The prohibited word filtering module 142 may filter messages by outputting “0” as a value for messages containing profanity or slanderous expressions, and outputting “1” as a value for messages not containing profanity or slanderous expressions.

The context of the text derived from the malicious message filtering module 143 and the prohibited word filtering module 142 may be grasped (or otherwise determined), and based on the grasped context, the text may be filtered to determine whether an artist message or a fan message corresponds to a malicious message.

The malicious message filtering module 143 may perform encoding using bidirectional context analysis on artist and/or fan messages to classify the context of the artist and/or fan messages. For instance, the malicious message filtering module 143 may input an artist and/or fan messages into the BERT learning model to filter out whether the fan messages are malicious messages. The BERT learning model used in association with the malicious message filtering module 143 may receive a single embedding that collects token embedding, segment embedding, and/or position embedding for the artist and/or fan messages and may grasp the context of the artist and/or fan message.

In some embodiments, the malicious message filtering module 143 may prevent out-of-vocabulary of words that configure artist and/or fan messages by using word piece embedding that segments words into sub-word units as token embedding.

For example, the malicious message filtering module 143 may process token embedding using a word piece embedding method. For the word piece embedding, embedding may be performed in units smaller than words, and the longest sub-word may be set as one unit. Frequently appearing sub-words may be utilized as units for embedding, and infrequently appearing words (or rare words) may be separated into sub-words. Conventional word embedding methods have an out-of-vocabulary issue, making it difficult to learn or translate rare words, names, numbers, or words that do not exist in a vocabulary list. On the other hand, the word piece embedding method according to various embodiments may be applied to all languages, and may segment words into sub-word units, and thus, it may be effective in addressing the out-of-vocabulary issue and also increasing accuracy.

In some implementations, the malicious message filtering module 143 may receive two sentences along with a sentence delimiter ([SEP]). Due to limitations on input length, the total length of the two sentences may be limited to 512 sub-words or less, but embodiments are not limited to such sizes. Even still, as the length of the input increases, the learning time may increase squarely (or exponentially) such that limiting the length of the input may be set appropriately to achieve a desired balance between input length and learning/processing time. Taking Korean as an example, given that Korean consists of an average of 20 sub-words and 99% of sentences typically do not exceed 60 sub-words, the length of the input may be limited to 128 for two sentence combinations. This limiting technique may be adjusted based on the language(s) being analyzed. However, given that there may be relatively long sentences, a method may be used in which the length of the input is limited to 128 and training is performed first, and additional training is performed in the final stage for inputs longer (or greater) than 128.

In some embodiments, the malicious message filtering module 143 may use position encoding. To this end, a transformer model may be applied, and the transformer model may use a self-attention model without using a CNN or a recurrent neural network (RNN) model, but embodiments are not limited thereto. Given that the self-attention model does not reflect the location of the input, additional location information on an input token may be provided as an additional input. Accordingly, in the transformer model, positional encoding using, for instance, a Sinusoid function may be used, and may be modified to use the positional encoding in the malicious message filtering module 143. In the positional encoding, encoding may be performed simply by a token order, such as 0, 1, 2, . . . .

The malicious message filtering module 143 may collect token embedding, segment embedding, and position embedding to generate one embedding (e.g., a single embedding) value. The single embedding may be generated in the form of a feature map, and may be used after being modified into an appropriate form according to the subsequent operation process. For example, the malicious message filtering module 143 may use the result of applying layer normalization and dropout to the single embedding as input.

The malicious message filtering module 143 may increase the accuracy of malicious message determination by providing the output malicious message encoding value to a fine tuning network. For example, the malicious message filtering module 143 may receive, for instance, two sentences regarding the message of a user as input along with the sentence delimiter ([SEP]), and may be built through pre-learning to generate a malicious message encoding value regarding the possibility of a malicious message as output through an internal inference stage.

The malicious message filtering module 143 may perform a malicious comment filter operation by directly utilizing the BERT learning model, but the accuracy of malicious message determination may be improved through additional learning. To this end, the malicious message filtering module 143 may define a model architecture that combines the BERT learning model and the fine-tuning network and utilize the combination in a malicious message determination process.

The malicious message filtering module 143 may determine the possibility of an artist message or a fan message being a malicious message by providing the malicious message encoding value to a one-dimensional convolution layer (1D convolution layer) or by performing an ensemble calculation based on a variable kernel size to generate a feature map and providing the feature map to a bidirectional long short-term memory (BiLSTM) network.

According to embodiments, the malicious message filtering module 143 may perform binary classification on the possibility of malicious messages by passing the results output through the BiLSTM network to affine and softmax layers. The BiLSTM or bidirectional LSTM, may correspond to a structure that uses two independent LSTM architectures together. First, the bidirectional LSTM may receive sentences sequentially.

For example, sentences may be input sequentially from the left, like a human reader. The bidirectional LSTM may be used in conjunction with a reverse LSTM, which reads sentences from right to left to take into account the context behind the sentences. The bidirectional LSTM may use both types of information by connecting the outputs of forward and backward LSTMs as part of making predictions in an output layer.

The bidirectional LSTM may enable end-to-end learning, which learns all (or substantially all) parameters simultaneously (or relatively simultaneously) while minimizing loss for output values, and may improve performance by internalizing the similarity between words and phrases into an input vector. In the case of the bidirectional LSTM, the basic performance of LSTM and the introduction of attention mechanism may have the advantage of not degrading performance even in instances in which the length of data is long.

In some embodiments, the malicious message filtering module 143 may implement a malicious message filter by combining the BERT learning model and the CNN learning model. For instance, the malicious message filtering module 143 may input a malicious message encoding value into the 1D convolution layer, input an output of the 1D convolution layer into a Gaussian error linear unit (GeLU) layer, input an output of the GeLU layer into a MaxPooling layer, and generate a binary classification result based on an output of the MaxPooling layer. A linear classification method may be applied to binary classification.

For example, the linear classification method may include linear regression or linear classification models.

In some implementations, the malicious message filtering module 143 may implement a malicious message filter by combining the BERT learning model and an ensemble CNN model. For instance, the malicious message filtering module 143 may perform: a first stage of performing an ensemble calculation based on a variable kernel size based on a malicious message encoding value; a second stage of independently inputting results of the ensemble calculation to a GeLU layer; a third stage of independently inputting outputs of the GeLU layer to a MaxPooling layer; a fourth stage of sequentially connecting outputs of the MaxPooling layer to generate an intermediate value; a fifth stage of inputting the intermediate value to an affine layer; a sixth stage of inputting an output of the affine layer to a softmax layer; and a seventh stage of generating a binary classification result based on a result of the softmax layer.

The ensemble calculation based on the variable kernel size may correspond to a plurality of convolution calculations performed by applying different kernel sizes to the same malicious message encoding value. The convolution calculation may include a 1D convolution calculation. For instance, a malicious comment determination unit 230 may independently apply kernels with different sizes to feature maps corresponding to malicious comment encoding values to perform each of the plurality of convolution calculations. Thereafter, the malicious message filtering module 143 may perform a classification operation regarding the possibility of an artist message or a fan message being a malicious message through a stage of integrating the results of each of the convolution calculations (e.g., the fourth stage).

The malicious message filtering module 143 may implement a malicious message filter by combining the BERT learning model, the ensemble CNN model, and the BiLSTM. For example, the malicious message filtering module 143 may perform: a first stage of performing an ensemble calculation based on a variable kernel size based on a malicious comment encoding value; a second stage of independently inputting results of the ensemble calculation to a GeLU layer; a third stage of independently inputting outputs of the GeLU layer to a MaxPooling layer; a fourth stage of sequentially connecting outputs of the MaxPooling layer to generate an intermediate value; a fifth stage of applying the intermediate value to a BiLSTM model; a sixth stage of inputting a result of application to the BiLSTM model to an affine layer; a seventh stage of inputting an output of the affine layer to a softmax layer; and an eighth stage of generating a binary classification result based on a result of the softmax layer.

The malicious message filtering module 143 may implement a malicious message filter by adding a stage of applying the intermediate value to the BiLSTM model between the fourth and fifth stages of the method of implementing a malicious message filter by combining the BERT learning model and the ensemble CNN model.

In some embodiments, for filtering malicious messages, the control unit 141 may derive a malicious message prediction score based on a frequency of use of a prohibited word of an artist or a fan, contextual information of the artist or fan message, and a frequency of writing the malicious message of the artist or fan. The control unit 141 may provide an artist or fan message review request notification to the artist terminal 200-1 or the fan terminal 200-2 in response to the derived malicious message prediction score being greater than or equal to a preset first reference score. The control unit 141 may provide a notification to stop sending artist or fan messages in response to the derived malicious message prediction score being greater than or equal to a preset second reference score. The second reference score may be set to have a value higher than the first reference score.

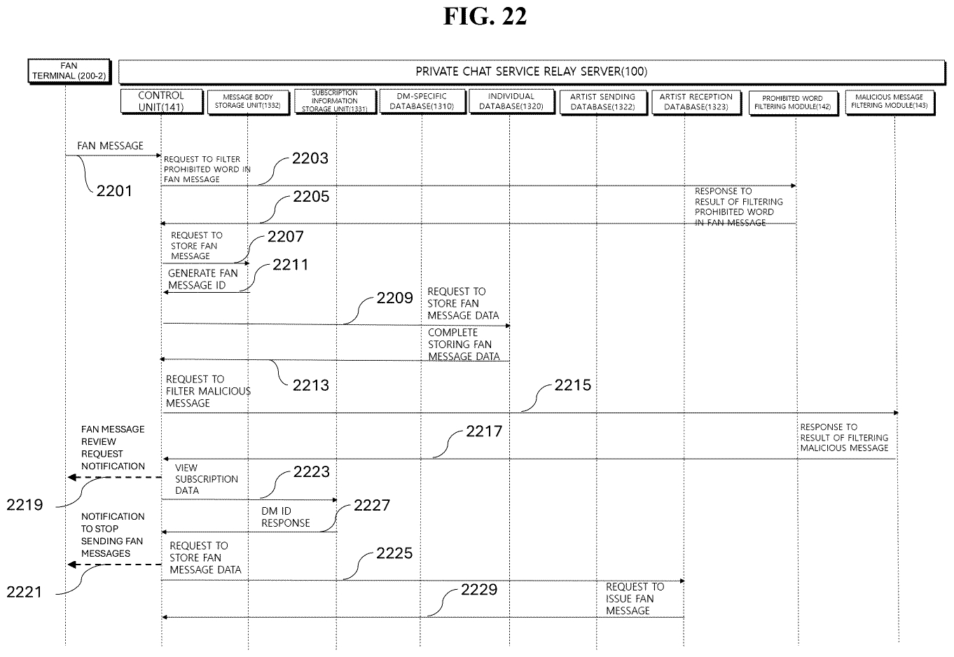

An example data processing process for filtering fan messages will now be described in more detail with reference to FIG. 22.

FIG. 22 is a schematic data flow diagram illustrating fan message filtering according to an embodiment.

Referring to FIG. 22, for fan messages, filtering a prohibited word and filtering a malicious message may be additionally performed for message filtering.

For example, in response to the control unit 141 receiving a fan message from the fan terminal 200-2 in 1601, the control unit 141 may request the prohibited word filtering module 142 to filter prohibited words for the fan message at 1603.

The prohibited word filtering module 142 that receives the prohibited word filtering request may filter whether the fan message contains prohibited words based on the fan prohibited words set for the reception entity artist.

As described with reference to FIG. 21, the prohibited word filtering module 142 may convert fan messages into images. The prohibited word filtering module 142 may derive text corresponding to the converted image data, identify words included in the derived text, and determine whether the identified words correspond to prohibited words to perform prohibited word filtering of fan messages.

The prohibited word filtering module 142 may respond with the fan message filtering result to the control unit 141 at 1605, and in response to the fan message not containing a prohibited word, the control unit 141 may perform a request to store the fan message to the message body storage unit 1332 per 1607 and a request to store the fan message data to the individual database 1320 as part of 1609. The message body storage unit 1332 may generate and provide a fan message ID to the control unit 141 in response to successfully storing the fan message in 1611. The individual database 1320 may provide an indication or message to the control unit 141, at 1613, indicating successful storage of the fan message data.

In response to the fan message being completely stored in the individual database 1320, the control unit 141 may request the malicious message filtering module 143 to filter the malicious message per 1615. The malicious message filtering module 143 that receives a malicious message filtering request may classify the context of the fan message and filter whether the fan message corresponds to a malicious message based on the classified context. A result of the classification and filtering may be transmitted to the control unit 141 by the malicious message filtering module 143 in 1617.

As described with reference to FIG. 21, the malicious message filtering module 143 may perform encoding using the bidirectional context analysis on fan messages to classify the context of the fan messages. The malicious message filtering module 143 may input fan messages into the BERT learning model to filter out whether the fan messages are malicious messages. The BERT learning model used in the malicious message filtering module 143 may receive a single embedding that collects token embedding, segment embedding, and position embedding for the fan message, grasp the context of the fan message, and classify the malicious message.

The control unit 141 that receives a malicious message filtering result from the malicious message filtering module 143 in 1617 may derive the malicious message prediction score based on the frequency of use of prohibited words by the received fan, the context information of the fan message, and the frequency of writing malicious messages by the fan.

In some implementations, the control unit 141 may provide a fan message review request notification to the fan terminal 200-2 at 1619 in response to the derived malicious message prediction score being greater than or equal to a preset first reference score. The control unit 141 may provide a notification to stop sending fan messages to the fan terminal 200-2 as part of 1621 in response to the derived malicious message prediction score being greater than or equal to a preset second reference score. The second reference score may be set to have a value higher than the first reference score.

In a case in which the fan message does not correspond to a malicious message as a result of filing malicious messages, the control unit 141 may perform a subscription data viewing using the subscription information storage unit 1331 per 1623 and may request the fan message to be stored in the artist reception database 1323 at 1625. The subscription information storage unit 1331 may respond, in 1627, with a DM ID response message corresponding to the subscription data viewing. In response to storing the fan message, the artist reception database 1323 may respond to the control unit 141 with a request to issue the fan message in 1629.

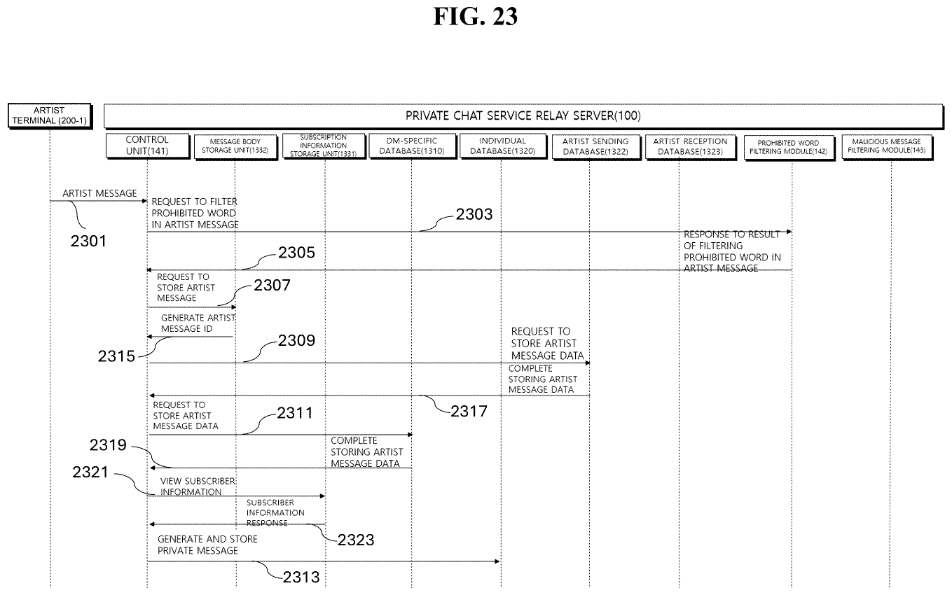

With reference to FIG. 23, an example data processing process for filtering artist messages will now be described in more detail.

FIG. 23 is a schematic data flow diagram illustrating artist message filtering according to an embodiment.

Referring to FIG. 23, for artist messages, filtering a prohibited word may be additionally performed for message filtering.

For example, in a case that the control unit 141 receives an artist message from the artist terminal 200 in 1701, the control unit 141 may request the prohibited word filtering module 142 to filter prohibited words for the artist message at 1703.

The prohibited word filtering module 142 that receives a prohibited word filtering request may filter whether the artist message contains a prohibited word based on the artist prohibited words set for the artist who writes the message.

In some implementations, such as described with reference to FIG. 21, the prohibited word filtering module 142 may convert the artist message into an image. The prohibited word filtering module 142 may derive text corresponding to the converted image data, identify words included in the derived text, and determine whether the identified words correspond to prohibited words to perform prohibited word filtering of the artist message.

The prohibited word filtering module 142 may respond, per 1705, with the artist message filtering result to the control unit 141. In response to the artist message not containing a prohibited word, the control unit 141 may perform a request to store the artist message in the message body storage unit 1332 at 1707, a request to store the artist message in the artist sending database 1322 in 1709, a request to store the artist message in the DM-specific database 1310 per 1711, and a request to generate and store the private message in the individual database 1320 in 1713. In response to the request to store the artist message in the message body storage unit 1332, the message body storage unit 1332 may respond to the control unit 141 with a generated artist message ID at 1715. The artist sending database 1322 may respond to the control unit 141, per 1717, notifying the control unit 141 of successful storage of the artist message data. As a response to the request to store the artist message in the DM-specific database 1310, the DM-specific database 1310 may respond to the control unit 141 with a storage complete response indicating successful storage of the artist message data in 1719.

In a case in which the artist message does not contain a prohibited word, the control unit 141 may perform a subscription data viewing using the subscription information storage unit 1331 per 1721. The subscription information storage unit 1331 may respond, in 1723, with a subscription information response corresponding to the subscription data viewing.

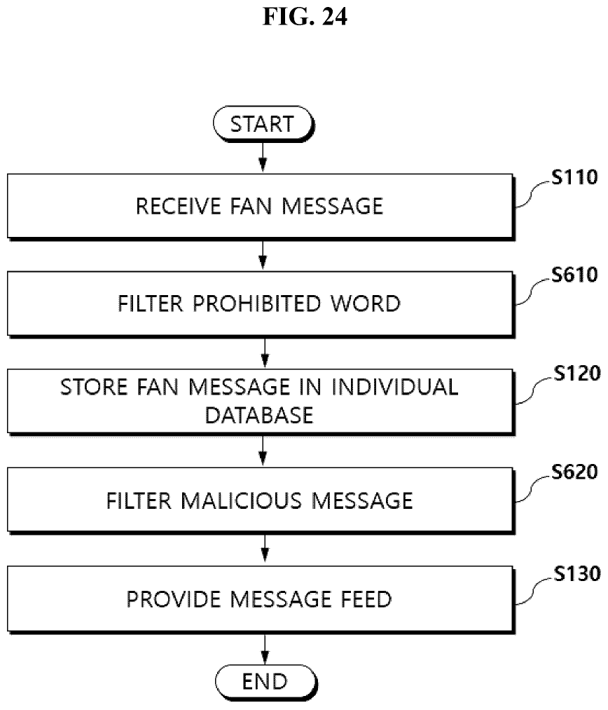

An example method for filtering fan messages will now be described in more detail with reference to FIG. 24.

FIG. 24 is a schematic flowchart of a fan message filtering method according to an embodiment.

Referring to FIG. 24, in the case of the method for filtering the fan messages, filtering a prohibited word S610 and filtering a malicious message S620 may be additionally included in the method for storing the fan message described in association with FIG. 10.

In the filtering of the prohibited word (S610), in response to the control unit 141 receiving a fan message from the fan terminal 200-2, the control unit 141 may request the prohibited word filtering module 142 to filter prohibited words for the fan message.

In the filtering of the prohibited word (S610), the prohibited word filtering module 142 that receives the prohibited word filtering request may filter whether the fan message contains prohibited words based on the fan prohibited words set for the reception entity artist.

In the filtering of the prohibited word (S510), the prohibited word filtering module 142 may convert fan messages into images. The prohibited word filtering module 142 may derive text corresponding to the converted image data, identify words included in the derived text, and determine whether the identified words correspond to prohibited words to perform prohibited word filtering of fan messages.

The prohibited word filtering module 142 may respond with the fan message filtering result to the control unit 141, and the control unit 141 may perform the storage of the fan message (S120) in the individual database in response to the fan message not containing a prohibited word.

In the filtering of the prohibited word (S610), the prohibited word filtering module 142 may convert artist message data and fan message data into image data using the CNN learning model.

For example, the prohibited word filtering module 142 may convert the text corresponding to the image data into, for example, Korean consonants and vowels, respectively, upon derivation. As previously mentioned, any other suitable language may be utilized other than or in addition to Korean. For descriptive convenience, it will be assumed that the language is Korean. As an operational example, in response to an artist message or fan message containing content, such as “ [symbol] ” or “ [symbol] ,” the prohibited word filtering module 142 may convert the message into an image to derive the consonants “ [symbol] ” and “ [symbol] ”, and the vowels “ [symbol] ” and “ [symbol] ” A combination of vowels and consonants, such as “ [symbol] ” which means “shit” in English and “ [symbol] ” which means “fuck” in English may be derived as text.

In some embodiments, the CNN may be configured of or include a portion that extracts features of an image and a portion that classifies the image in a way that effectively recognizes and emphasizes the features from adjacent images while maintaining spatial information of the image. A feature extraction region may be configured of a convolution layer that finds features of an image while minimizing the number of shared parameters using a filter, and a pooling layer that strengthens and collects the features. Given that it may be possible to retrain and use the CNN for new (or other) recognition tasks based on existing networks, CNN-trained models may filter out new malicious messages that are creatively modified to avoid prohibited words, such as substituting numbers or symbols for characters or letters, spacing or breaking up words, using phonetic or foreign language variants, intentionally misspelling words, deriving creative plays on words, employing emojis and/or visual substitutions, employing code words, slang, and/or inside jokes, etc.

In some implementations, in the filtering of the prohibited word (S610), the prohibited word filtering module 142 may filter whether a prohibited word is included in the text derived using a bidirectional encoder representations from transformers (BERT) learning model. The BERT learning model may be fine-tuned using the accuracy of the determination results.

The BERT learning model is a pre-trained learning model that Google uses to label and train on a large number of articles on the web (or Internet) using semi-supervised learning. The BERT learning model may be used in the embedding process associated with performing tasks, such as named entity recognition and text classification.

As a method for determining whether a prohibited word is included by the prohibited word filtering module 142, a method using an algorithm that labels a message containing a vocabulary preset by a user or a determination method based on a preset reference may be used.

The preset reference may be categorized into expressions that include at least one of general profanity, vulgarity, and degrading expressions that are offensive to others, sexually provocative expressions, expressions that involve physical threats, expressions of discrimination based on region/race/country/religion/sexual orientation, derogatory expressions that cause humiliation and/or shame to others, and any other suitable categorization.

In the filtering of the prohibited word (S610), the prohibited word filtering module 142 may filter messages by outputting “0” as a value for messages containing profanity or slanderous expressions, and outputting “1” as a value for messages not containing profanity or slanderous expressions.

In response to the fan message being completely stored in the individual database 1320, in the filtering of the malicious message (S620), the control unit 141 may request the malicious message filtering module 143 to filter the malicious message. In the filtering of the malicious message (S620), the malicious message filtering module 143 that receives a malicious message filtering request may classify the context of the fan message and filter whether the fan message corresponds to a malicious message based on the classified context.

In the filtering of the malicious message (S620), the context of the text derived from the malicious message filtering module 143 and the prohibited word filtering module 142 may be grasped, and based on the grasped context, the text may be filtered to determine whether the fan message corresponds to a malicious message.

To this end, the malicious message filtering module 143 may perform encoding using the bidirectional context analysis on fan messages to classify the context of the fan message.

In the filtering of the malicious message (S620), the malicious message filtering module 143 may input fan messages into the BERT learning model to filter out whether the fan messages are malicious messages. The BERT learning model used in the malicious message filtering module 143 may receive a single embedding that collects token embedding, segment embedding, and position embedding for the fan message, grasp the context of the fan message, and classify the malicious message.

In the filtering of the malicious message (S620), the malicious message filtering module 143 may perform encoding using the bidirectional context analysis on fan messages to classify the context of the fan messages. For instance, the malicious message filtering module 143 may input the fan message into the BERT learning model to filter out whether the fan message is a malicious message. The BERT learning model used in the malicious message filtering module 143 may receive a single embedding that collects token embedding, segment embedding, and position embedding for the fan message and grasp the context of the fan message.

In some embodiments, the malicious message filtering module 143 may prevent out-of-vocabulary of words that configure fan messages by using word piece embedding that segments words into sub-word units as token embedding.

For example, the malicious message filtering module 143 may process token embedding using a word piece embedding method. For the word piece embedding, embedding may be performed in units smaller than words, and the longest sub-word may be set as one unit. Frequently appearing sub-words may be utilized as units for embedding, and infrequently appearing words (or rare words) may be separated into sub-words. Conventional word embedding methods have an out-of-vocabulary issue, making it difficult to learn or translate rare words, names, numbers, or words that do not exist in a vocabulary list. On the other hand, the word piece embedding method according to various embodiments may be applied to all languages, and may segment words into sub-word units, and thus, it may be effective in addressing the out-of-vocabulary issue and also increasing accuracy.

In the filtering of the malicious message (S620), the malicious message filtering module 143 may receive two sentences along with a sentence delimiter ([SEP]). Due to limitations on input length, the total length of the two sentences may be limited to 512 sub-words or less, but embodiments are not limited to such sizes. Even still, as the length of the input increases, the learning time may increase squarely (or exponentially) such that limiting the length of the input may be set appropriately to achieve a desired balance between input length and learning/processing time. Taking Korean as an example, given that Korean consists of an average of 20 sub-words and 99% of sentences typically do not exceed 60 sub-words, the length of the input may be limited to 128 for two sentence combinations. This limiting technique may be adjusted based on the language(s) being analyzed. However, given that there may be relatively long sentences, a method may be used in which the length of the input is limited to 128 and training is performed first, and additional training is performed in the final stage for inputs longer (or greater) than 128.

In some embodiments, in the filtering of the malicious message (S620), the malicious message filtering module 143 may use position encoding. To this end, a transformer model may be applied, and the transformer model may use a self-attention model without using a CNN or RNN model, but embodiments are not limited thereto. Given that the self-attention model does not reflect the location of the input, additional location information on an input token may be provided as an additional input. Accordingly, in the transformer model, positional encoding using, for instance, a Sinusoid function may be used, and may be modified to use the positional encoding in the malicious message filtering module 143. In the positional encoding, encoding may be performed simply by a token order, such as 0, 1, 2, . . . .

According to some embodiments, in the filtering of the malicious message (S620), the malicious message filtering module 143 may collect token embedding, segment embedding, and position embedding to generate one embedding (e.g., a single embedding) value. The single embedding may be generated in the form of a feature map, and may be used after being modified into an appropriate form according to the subsequent operation process. For example, the malicious message filtering module 143 may use the result of applying layer normalization and dropout to the single embedding as input.

In some implementations, in the filtering of the malicious message (S620), the malicious message filtering module 143 may increase the accuracy of malicious message determination by providing the output malicious message encoding value to a fine tuning network. For example, the malicious message filtering module 143 may receive, for instance, two sentences regarding the message of a user as input along with the sentence delimiter ([SEP]), and may be built through pre-learning to generate a malicious message encoding value regarding the possibility of a malicious message as output through an internal inference stage.

In the filtering of the malicious message (S620), the malicious message filtering module 143 may perform a malicious comment filter operation by directly utilizing the BERT learning model, but the accuracy of malicious message determination may be improved through additional learning. To this end, the malicious message filtering module 143 may define a model architecture that combines the BERT learning model and the fine-tuning network and utilize the combination in a malicious message determination process.

The malicious message filtering module 143 may determine the possibility of a fan message being a malicious message by providing the malicious message encoding value to a one-dimensional convolution layer (1D convolution layer) or by performing an ensemble calculation based on a variable kernel size to generate a feature map and providing the feature map to a bidirectional long short-term memory (BiLSTM) network.

According to embodiments, in the filtering of the malicious message (S620), the malicious message filtering module 143 may perform binary classification on the possibility of malicious messages by passing the results output through the BiLSTM network to affine and softmax layers. The BiLSTM or bidirectional LSTM, may correspond to a structure that uses two independent LSTM architectures together. First, the bidirectional LSTM may receive sentences sequentially.

For example, sentences may be input sequentially from the left, like a human reader. The bidirectional LSTM may be used in conjunction with a reverse LSTM, which reads sentences from right to left to take into account the context behind the sentences. The bidirectional LSTM may use both types of information by connecting the outputs of forward and backward LSTMs as part of making predictions in an output layer.

The bidirectional LSTM may enable end-to-end learning, which learns all (or substantially all) parameters simultaneously (or relatively simultaneously) while minimizing loss for output values, and may improve performance by internalizing the similarity between words and phrases into an input vector. In the case of the bidirectional LSTM, the basic performance of LSTM and the introduction of attention mechanism may have the advantage of not degrading performance even in instances in which the length of data is long.

In some embodiments, in the filtering of the malicious message (S620), the malicious message filtering module 143 may implement a malicious message filter by combining the BERT learning model and the CNN learning model. For instance, the malicious message filtering module 143 may input a malicious message encoding value into the 1D convolution layer, input an output of the 1D convolution layer into a GeLU layer, input an output of the GeLU layer into a MaxPooling layer, and generate a binary classification result based on an output of the MaxPooling layer. A linear classification method may be applied to binary classification.

For example, the linear classification method may include linear regression or linear classification models.

In some implementations, in the filtering of the malicious message (S620), the malicious message filtering module 143 may implement a malicious message filter by combining the BERT learning model and an ensemble CNN model. For instance, the malicious message filtering module 143 may perform: a first stage of performing an ensemble calculation based on a variable kernel size based on a malicious message encoding value; a second stage of independently inputting results of the ensemble calculation to a GeLU layer; a third stage of independently inputting outputs of the GeLU layer to a MaxPooling layer; a fourth stage of sequentially connecting outputs of the MaxPooling layer to generate an intermediate value; a fifth stage of inputting the intermediate value to an affine layer; a sixth stage of inputting an output of the affine layer to a softmax layer; and a seventh stage of generating a binary classification result based on a result of the softmax layer.

The ensemble calculation based on the variable kernel size may correspond to a plurality of convolution calculations performed by applying different kernel sizes to the same malicious message encoding value. The convolution calculation may include a 1D convolution calculation. For instance, a malicious message filtering module 143 may independently apply kernels with different sizes to feature maps corresponding to malicious comment encoding values to perform each of the plurality of convolution calculations. Thereafter, the malicious message filtering module 143 may perform a classification operation regarding the possibility of an artist message or a fan message being a malicious message through a stage of integrating the results of each of the convolution calculations (e.g., the fourth stage).

According to some embodiments, in the filtering of the malicious message (S620), the malicious message filtering module 143 may implement a malicious message filter by combining the BERT learning model, the ensemble CNN model, and the BiLSTM. For example, the malicious message filtering module 143 may perform: a first stage of performing an ensemble calculation based on a variable kernel size based on a malicious comment encoding value; a second stage of independently inputting results of the ensemble calculation to a GeLU layer; a third stage of independently inputting outputs of the GeLU layer to a MaxPooling layer; a fourth stage of sequentially connecting outputs of the MaxPooling layer to generate an intermediate value; a fifth stage of applying the intermediate value to a BiLSTM model; a sixth stage of inputting a result of application to the BiLSTM model to an affine layer; a seventh stage of inputting an output of the affine layer to a softmax layer; and an eighth stage of generating a binary classification result based on a result of the softmax layer.

The malicious message filtering module 143 may implement a malicious message filter by adding a stage of applying the intermediate value to the BiLSTM model between the fourth and fifth stages of the method of implementing a malicious message filter by combining the BERT learning model and the ensemble CNN model.

In the filtering of the malicious message (S620), for filtering malicious messages, the control unit 141 may derive a malicious message prediction score based on the frequency of use of prohibited words of fans, contextual information of fan messages, and the frequency of writing malicious messages of fans.

In the filtering of the malicious message (S620), the control unit 141 may provide a fan message review request notification to the fan terminal 200 in response to the derived malicious message prediction score being higher than a preset first reference score. The control unit 141 may provide a notification to stop sending fan messages in response to the derived malicious message prediction score being higher than a preset second reference score. The second reference score may be set to have a higher value than the first reference score.

In instances in which the fan message does not correspond to a malicious message as a result of the filing of the malicious message, the provision of the message feed (S130) may be performed.

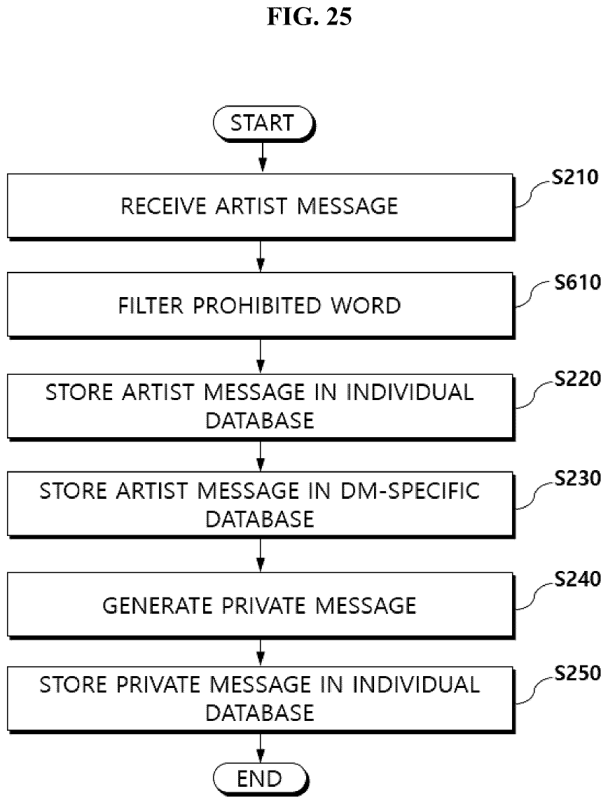

An example artist message filtering method will now be described in more detail with reference to FIG. 25.

FIG. 25 is a schematic flowchart of an artist message filtering method according to an embodiment.

Referring to FIG. 25, in the case of the artist message filtering method, filtering a prohibited word (S511) may be additionally performed in the method for storing the artist message previously described in association with FIG. 11.

In the filtering of the prohibited word (S511), in response to the control unit 141 receiving an artist message from the artist terminal 200, the control unit 141 may request the prohibited word filtering module 142 to filter prohibited words for the artist message.

In the filtering of the prohibited word (S511), the prohibited word filtering module 142 that receives the prohibited word filtering request may filter whether the artist message contains a prohibited word based on the artist prohibited words set for the artist who writes the message.

As described above, the prohibited word filtering module 142 may convert the artist message into an image. The prohibited word filtering module 142 may derive text corresponding to the converted image data, identify words included in the derived text, and determine whether the identified words correspond to prohibited words to perform prohibited word filtering of the artist message.

The prohibited word filtering module 142 may respond with the artist message filtering result to the control unit 141. In response to the artist message not containing a prohibited word, the control unit 141 may perform: the storage of the artist message in the individual database (S220); the storage of the artist message in the DM-specific database (S230); the generation of the private message (S240); and the storage of the private message (S250) in the individual database (1321).

According to various embodiments, the artist terminal 200-1 and the fan terminal 200-2 may correspond to an artist account and a fan account, or a terminal logged in using the artist account and a terminal logged in using the fan account.

Although the foregoing embodiments have been described in some detail for purposes of clarity of understanding, it will be apparent that certain changes and modifications may be practiced within the scope of the appended claims. It should be noted that there are many alternative ways of implementing the processes, systems, and apparatuses of the disclosed embodiments. Accordingly, embodiments are to be considered illustrative and not as restrictive, and embodiments are not to be limited to the details given herein.

1. A method for providing a private chat service by relaying messages between an artist terminal and a plurality of fan terminals via a private chat service relay server, the method comprising:
receiving an artist message for transmission from the artist terminal to a fan terminal among the plurality of fan terminals;
transferring the artist message to a determined reviewer terminal;
waiting to send the artist message to the fan terminal until the reviewer terminal approves the sending of the artist message;
storing the artist message in the private chat service relay server in response to the reviewer terminal approving the sending of the artist message;
converting the artist message stored in the private chat service relay server into a private message; and
transferring the private message to the fan terminal,
wherein the private message is a message in which a word or keyword of the artist messages is converted according to a reception entity.

2. The method of claim 1, wherein
transferring of the artist message to the determined reviewer terminal comprises:
storing the artist message and artist information in an artist sending database;
generating and providing a message feed to the reviewer terminal; and
receiving the artist message and the artist information from the artist sending database, generating a review message, and transferring the review message to the reviewer terminal in response to a message view being requested from the reviewer terminal, and
the message feed includes a notification and a post indicating receipt of a message on the reviewer terminal.

3. The method of claim 2, wherein generation of the review message and transfer of the review message to the reviewer terminal comprise:
generating a text message containing content of the artist message and a link for selecting whether to approve the sending of the artist message; and
transferring the text message and the link to the reviewer terminal.

4. The method of claim 2, wherein
generation of the review message and transfer of the review message to the reviewer terminal comprise;
generating a message containing content of the artist message and a link for selecting whether to approve the sending of the artist message; and
transferring the message to the reviewer terminal, and
the message is as a message of an application enabling transmission and reception of messages.

5. The method of claim 2, wherein waiting to send the artist message comprises:
deleting the artist message stored in the artist sending database in response to the reviewer terminal rejecting the sending of the artist message; and
transferring a message rejecting the sending of the artist message to the artist terminal.

6. The method of claim 5, wherein the storage of the artist message in the private chat service relay server comprises:
receiving an amended message for the artist message from the reviewer terminal;
storing the amended message in the private chat service relay server;
converting the amended message into the private message; and
transferring the private message to the fan terminal.

7. The method of claim 6, wherein
conversion of the artist message into the private message and transfer of the private message to the fan terminal comprises:
storing the artist message and artist information or the amended message and artist information in a direct message (DM)-specific database;
generating and providing the message feed to the artist terminal or the plurality of fan terminals;
receiving a request for a message update of a private chat from a first fan terminal requesting a view of the artist message among the plurality of fan terminals;
generating the private message corresponding to the first fan terminal based on the amended message or artist message and fan account information corresponding to the first fan terminal; and
transferring the private message to the first fan terminal, and
the DM-specific database is configured to store artist messages on an artist-by-artist basis.

8. The method of claim 7, wherein storage of the artist message and the artist information or the amended message and the artist information in the DM-specific database comprises:
matching a plurality of individual databases respectively corresponding to of the plurality of fan terminals;
generating a plurality of private messages respectively corresponding to the plurality of fan terminals based on the amended message or artist message and fan account information respectively corresponding to the plurality of fan terminals; and
storing the plurality of private messages respectively in the plurality of individual databases corresponding to the plurality of fan terminals based on the fan account information.

9. The method of claim 8, wherein the transferring the private message to the first fan terminal comprises:
deleting the artist message stored in the DM-specific database in response to completion of storage of the plurality of private messages in the plurality of individual databases;
receiving the private message from a first individual database corresponding to the first fan terminal; and
transferring the private message to the first fan terminal.

10. The method of claim 9, wherein transferring the private message to the first fan terminal comprises:
deleting the artist messages stored in the DM-specific database in response to expiration of a determined reference time since the artist messages and artist information were stored in the DM-specific database;
receiving the private message from the first individual database, and
transferring the private message to the first fan terminal.

11. A method for providing a private chat service by relaying messages between an artist terminal and a plurality of fan terminals via a private chat service relay server, the method comprising:
displaying, on the artist terminal, a message input area and a message display area in association with the private chat service;
generating a review request message display area;
displaying an artist message in the review request message display area in response to the artist message being input using the message input area;
transferring the artist message to a determined reviewer terminal;
converting the artist message into a private message;
transferring the private message to a fan terminal among the plurality of fan terminals in response to the reviewer terminal approving sending of the artist message; and
moving the artist message displayed in the review request message display area to being displayed in the message display area in response to the artist message being transferred to the fan terminal,
wherein the private message is a message in which a word or keyword of the artist messages converted according to a reception entity.

12. The method of claim 11, wherein
transferring the artist message to the determined reviewer terminal comprises:
storing the artist message and artist information in an artist sending database;
displaying a message feed provided to the reviewer terminal; and
displaying the artist message and artist information in response to a message view being requested from the reviewer terminal, and
the message feed comprises a notification and a post indicating receipt of a message on the reviewer terminal.

13. The method of claim 12, wherein displaying the artist message and the artist information comprises displaying, on the reviewer terminal, a review message display area in which content of the artist message is displayed and a message review approval selection area for selecting whether to approve the sending of the artist message.

14. The method of claim 12, wherein movement and display of the artist message to the message display area comprises:
deleting the artist message stored in the artist sending database in response to the reviewer terminal rejecting the sending of the artist message; and
displaying a sending rejection message of the artist message on the artist terminal.

15. The method of claim 14, wherein displaying of the artist message and the artist information comprises:
displaying an amended message input area describing amended details of the artist message on the reviewer terminal;
storing the amended message input using the amended message input area in the private chat service relay server;
converting the amended message into the private message; and
transferring the private message to the fan terminal.

16. The method of claim 15, wherein
conversion of the amended message into the private message and transferring the private message to the fan terminal comprises:
storing the artist message and the artist information or the amended message and the artist information in a direct message (DM)-specific database;
generating and providing the message feed to the artist terminal or the plurality of fan terminals;
receiving a request for a message update in the private chat from a first fan terminal requesting a view of the artist message among the plurality of fan terminals;
generating the private message corresponding to the first fan terminal based on the amended message or the artist message and fan account information corresponding to the first fan terminal; and
transferring the private message to the first fan terminal, and
the DM-specific database is configured to store artist messages on an artist-by-artist basis.

17. The method of claim 16, wherein storage of the artist message and the artist information or the amended message and the artist information in the DM-specific database comprises: matching a plurality of individual databases respectively corresponding to the plurality of fan terminals;
generating a plurality of private messages respectively corresponding to the plurality of fan terminals based on the amended message or the artist message and fan account information respectively corresponding to the plurality of fan terminals; and
storing the plurality of private messages respectively in the plurality of individual databases corresponding to the plurality of fan terminals based on the fan account information.

18. The method of claim 17, wherein transferring the private message to the first fan terminal comprises:
deleting the artist message stored in the DM-specific database in response to completion of storage off the plurality of private messages in the plurality of individual databases;
receiving the private message from a first individual database corresponding to the first fan terminal, and
transferring the private message to the first fan terminal.

19. A device for providing a private chat service by relaying messages between an artist terminal and a plurality of fan terminals via a private chat service relay server, the device comprising:
a communication module that transmits and receives information among the artist terminal, a reviewer terminal, the fan terminal, and the private chat service relay server;
a memory that stores a private chat service program;
a direct message (DM)-specific database that stores the messages on an artist-by-artist basis;
a plurality of individual databases respectively allocated to users of the private chat service and that respectively stores the messages for the users; and
a processor that executes the private chat service program stored in the memory, wherein
in response to execution of the private chat service program, the processor is configured to:
receive an artist message for transmission from the artist terminal to a fan terminal among the plurality of fan terminals;
transfer the artist message to a determined reviewer terminal;
wait to send the artist message to the fan terminal until the reviewer terminal approves the sending of the artist message;
store the artist message in the private chat service relay server in response to the reviewer terminal approving the sending of the artist message;
convert the artist message stored in the private chat service relay server into a private message; and
transfer the private message to the fan terminal, and
the private message is a message in which a word or keyword of the artist messages is converted according to a reception entity.
